(19) United States
(12) Patent Application Publication
(10) Pub. No.: US 2010/0031137 A1
(43) Pub. Date: Feb. 4, 2010

(54) Method and system for authoring, publishing and rendering a dynamic interactive web page

(75) Inventors: Marc Arthur Amaral, Colorado Springs, CO (US); Kien-Lam Alain Hoang, Colorado Springs, CO (US)

Correspondence Address: Marc Amaral, 4284 Aryshire Lane, Colorado Springs, CO, 80922, US

(73) Assignee: RULE DYNAMICS INC., Colorado Springs, CO (US)

(21) Appl. No.: 12/362,470

(22) Filed: Jan. 29, 2009

Related U.S. Application Data
(60) Provisional application No. 61/028,508, filed on Feb. 13, 2008.

(51) Int. Cl. G06F 17/00; G06F 3/01

(52) U.S. Cl. 715/234; 715/760

(57) ABSTRACT

A system and method permitting users to author, publish, and render a dynamic interactive web page. The dynamic interactive web page is generated by a knowledge object which is a block of information composed of a plurality of action-condition rules. Knowledge objects may be used to build, but are not limited to building, question and answer facts, multiple choice trivia's, multiple choice quizzes, multiple choice test, polls, surveys, consultations, conversations, or complex problem resolution systems through series of information exchanges between a user and a knowledge object. Knowledge objects may provide needed knowledge in, but are not limited to, the following categories: Education, physics, history, geography, sciences, mathematics, mechanics, electronics, business, finances, entertainment, health, hobby, games, parenting, relationships, religion, real estate, shopping, sports, styles, toys, travel, trivia, etc. . . .

This application claims priority to, and the benefit of, U.S. Provisional Application Ser. No. 61/028,508, filed Feb. 13, 2008 and entitled “Online method and system for authoring, publishing and consuming knowledge objects”, the entire disclosure of which is herein incorporated by reference.

### FIELD OF THE INVENTION

The invention relates to online user created content data services, to conditions-actions driven computer systems, and more particularly to dynamic and interactive web page creation and rendering.

### BACKGROUND OF THE INVENTION

With the introduction of personal computers and the Internet (i.e. the World Wide Web), a variety of software and online services have become available for users to share knowledge and to seek answers to problems. Internet sites such as ehow.com, about.com, wikiHow.com, doityourself.com, and expertVillage.com help authors publish their “know how” and articles of interest, and allow users to search and read the published information. Outside of these specific web sites, authors may create their own customized web site using a variety of tools and publish their web site to the internet.

Authoring facilities offered by the above web sites or by web page authoring tools only offer static display of information. Authors needing to display information in such a way that the information displayed is chosen based on logical data comparison need to resort to using computer programming languages, computer programming scripts, computer interpretable tags mixed with the web page content, or computer interpretable tags residing in a separate file from the web page content. Understanding, authoring, running, debugging and maintaining these computer programming or computer tag facilities require a great deal of study and efforts and therefore restrict most authors from publishing other than static information. The same authoring restrictions apply for authors wanting to publish the result of a mathematic computation based on a user's input. With static information authoring facilities, an author can only choose to either describe how a user should perform the needed mathematic computation or provide a table of values with corresponding computed results in which the user's desired result may or may not be found.

Furthermore, consumers of published static information have to read loosely related or unrelated information prior to finding their needed information. The more complex the subject matter and the more precise the information needed is, the more volumes of irrelevant information users have to read in order to find the needed information. Although many web site offer search capabilities over their web site information, consumers may not know the full extent of what they are searching for, nor the precise combination of key words leading them directly to the information they are seeking, again causing them to read unrelated information, and also causing them to analyze loosely related information in order to determine if this information is needed.

### SUMMARY OF THE INVENTION

The system accepts a web page invocation, transforms it to invoking a plurality of rules and generates a web page by assembling the web page components generated by the rule(s) whose conditions are met. Each rule enables conditional web page components display, conditional computations, conditional user prompts, and conditional invocations of subsets of rules. The system enables authors to prompt users with upfront useful questions about the interested subject and in response to a user's input, displays only the relevant information. The author may include computations in order to provide precise information to a user's mathematical inquiry. The system is “Fill in the blanks” driven so that authors do not have to know a programming language, nor programming scripts, nor control tags, to evaluate what information needs to be displayed and what information needs to be skipped. The “Fill in the blanks” user interface enables easy knowledge object authoring and frees authors from the technical aspects of other computer implemented systems.

In accordance with one aspect of the invention, a system is provided to render a knowledge object, composed of a plurality of rules, as a dynamic interactive web page. The system provides the facilities to assemble, into a web page or into a portion of a web page, all the web page components generated by the actions of at least one rule whose conditions are met. Web page components generated by a rule's actions may be but are not limited to rendering text, text with variables substituted with their run time values, images, videos, sounds, prompts for user input, links each pointing to a knowledge object or links each pointing to a subset of rules within a knowledge object, submit control pointing to a knowledge object or pointing to a subset of rules within a knowledge object. The system also provides the facilities to reason upon previously provided inputs in order to decide if a rule's actions should be acted upon thus narrowing the scope of information returned to a user in order to quickly arrive at presenting the needed information and freeing the user from reading unnecessary information. It also provides facilities for evaluating a formula and displaying its results in the manner directed by the author. It also provides facilities for remembering a given fact. It also provides facilities for evaluating the run-time value of a variable and for displaying the substituted run-time value instead of the variable name in the manner directed by the author. It also provides the facilities to invoke singly or repetitively, within a knowledge object, a subset of rules not only enabling reuse of web page components but also enabling iterative computations. It also provides the facilities for calling another computer implemented system such as a database system or an external system.

In accordance with another aspect of the invention, a computer implemented interface is provided to author a dynamic and interactive web page using a plurality of rules (e.g. a knowledge object). The system provides facilities for authoring prompts for a user to enter information, facilities to author rule's conditions, facilities to author a formula and assign its result to a variable, facilities for authoring text including variables within the text, facilities for authoring rendering instructions for picture, video and sound objects, facilities for authoring a variable and its respective value, facilities for authoring a single or multiple invocation of a subset of rules within a knowledge object, facilities to author links each pointing to a knowledge object or each pointing to a subset of rules within a knowledge object and facilities for authoring a call to another computer implemented system. The computer implemented interface provides, to anyone of ordinary skills, an easy to use knowledge object authoring program freeing the authors from ordinary aspect of other computer implementation.

In accordance with yet another aspect, the invention provides an online computer system for permitting users in a data network to author, publish, find and experience knowledge objects rendered as dynamic interactive web pages. The system includes means of authoring, including categorizing, users' knowledge objects, means of publishing users' knowledge objects, means of searching published knowledge objects by key word, means of searching published knowledge objects by categories, means for combining search by key word and category, means for providing browsing access to the users of a list of relevant knowledge objects, and means of rendering a knowledge object as a dynamic interactive web page. Because the authoring program and its publishing facilities enable anyone with ordinary skills to create blocks of useful knowledge, the scope of potential applications is very large and its usage may lead to the creation of problem resolutions in unexpected knowledge areas.

In the following specifications and claims, 1) the term “web page component” means a set of instructions that, when executed by a web browser, renders a multimedia object on a web page, said multimedia object may be, but is not limited to, text, image, sound, video, link, input prompt, selection prompt, buttons, and layout; 2) the term “knowledge object” and the term “plurality of rules” are synonyms and shall be used interchangeably; 3) the term “rule” means a construct comprising condition(s) and action(s) that, when invoked, execute its actions only if its conditions are satisfied.

### BRIEF DESCRIPTION OF THE DRAWINGS

FIG. 1 is a block diagram of an embodiment of the invention, which uses a single server for authoring, publishing and rendering knowledge objects.

FIG. 2 is a block diagram of an embodiment of the invention, which uses multiple servers for authoring, publishing and rendering knowledge objects.

FIG. 3 is a listing of functions performed by the servers for authoring, publishing and rendering knowledge objects.

FIG. 4 is a block diagram showing a hierarchy of categories and sub-categories in the database of published knowledge objects.

FIG. 5 is a flow chart showing typical procedures followed during the search and rendering of knowledge objects.

FIG. 6 is a flow chart of “Run knowledge object” procedure within FIG. 5.

FIG. 7 is a flow chart of a subroutine called in the flow chart of FIG. 6 for evaluating the rules and executing the actions.

FIG. 8 is the first sheet of a flow chart of a subroutine called in the flow chart of FIG. 7 for executing actions.

FIG. 9 is a second sheet of a flow chart begun in FIG. 8.

FIG. 10 is a third sheet of a flow chart begun in FIG. 8.

FIG. 11 is a flow chart showing a typical procedure followed for authoring knowledge objects.

FIG. 12 is a flow chart showing a typical procedure for authoring and publishing a knowledge object within the “Author user's knowledge objects” procedure of FIG. 11.

FIG. 13 is a flow chart of the “Create rule” procedure within FIG. 12.

FIG. 14 is the first sheet of a flow chart of a “Create action” procedure within FIG. 13.

FIG. 15 is the second sheet of the flow chart begun in FIG. 14.

FIG. 16 is a flow chart of a “User enters variable. User may enter associated values” procedure within FIG. 14.

FIG. 17 is a flow chart of a “Create condition” procedure within FIG. 13.

FIG. 18 is a block diagram of the registered users' database containing the users' knowledge objects, files and variables.

FIG. 19 is a block diagram of the published knowledge objects database containing the published knowledge objects' rules, files and variables.

FIG. 20 shows a web page as seen by a user when browsing the database of published knowledge objects.

FIG. 21 shows a web page as seen by a user when experiencing an instance of a published knowledge object.

FIG. 22 is a display screen as seen by a user for authoring knowledge objects, variables and their associated values.

FIG. 23 shows a selected drop down menu of the knowledge object option on the menu bar in FIG. 22.

FIG. 24 shows a selected drop down menu of the rule option on the menu bar in FIG. 22.

FIG. 25 shows a selected drop down menu of the condition option on the menu bar in FIG. 22.

FIG. 26 shows a selected drop down menu of the action option on the menu bar in FIG. 22.

FIG. 27 shows a selected drop down menu of the variable option on the menu bar in FIG. 22.

FIG. 28 is a display screen as seen by a user for authoring a knowledge object.

FIG. 29 is a display screen as seen by a user for authoring a rule.

FIG. 30 is a display screen as seen by a user for authoring a variable.

FIG. 31 is a display screen as seen by a user for authoring a condition.

FIG. 32 is a display screen as seen by a user for authoring a text action.

FIG. 33 is a display screen as seen by a user for authoring a display file action.

FIG. 34 is a display screen as seen by a user for authoring an ask action.

FIG. 35 is a display screen as seen by a user for authoring a compute action.

FIG. 36 is a display screen as seen by a user for authoring a call rule set action.

FIG. 37 is a display screen as seen by a user when authoring a re-entry rule set action.

FIG. 38 is a display screen as seen by a user for authoring a call external application action.

FIG. 39 is a display screen as seen by a user for authoring a remember action.

### DETAILED DESCRIPTION

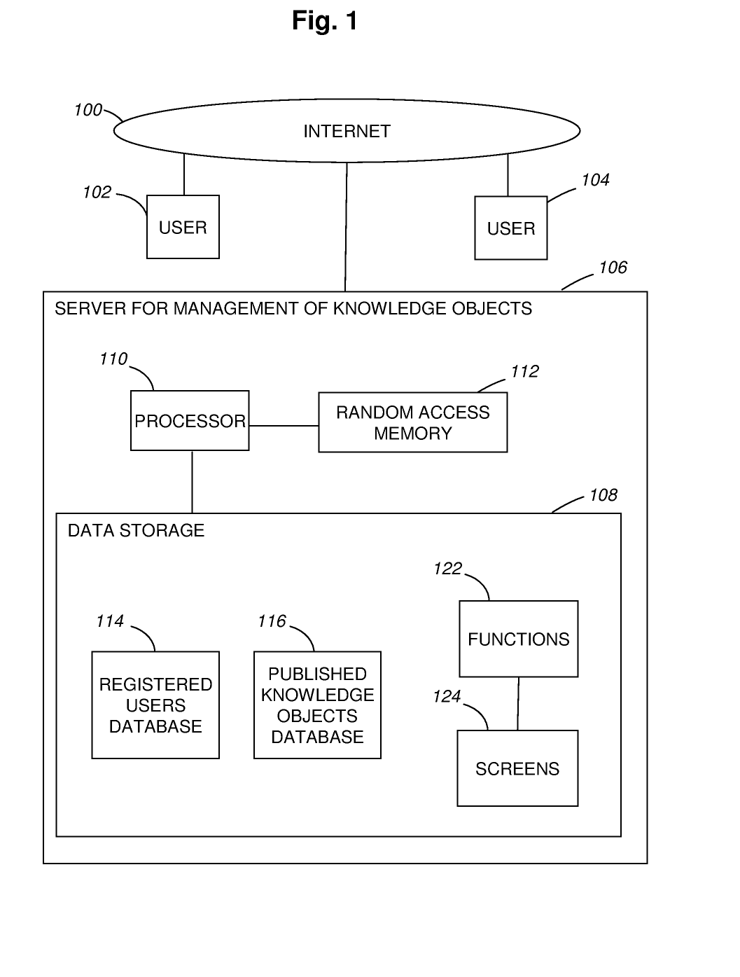

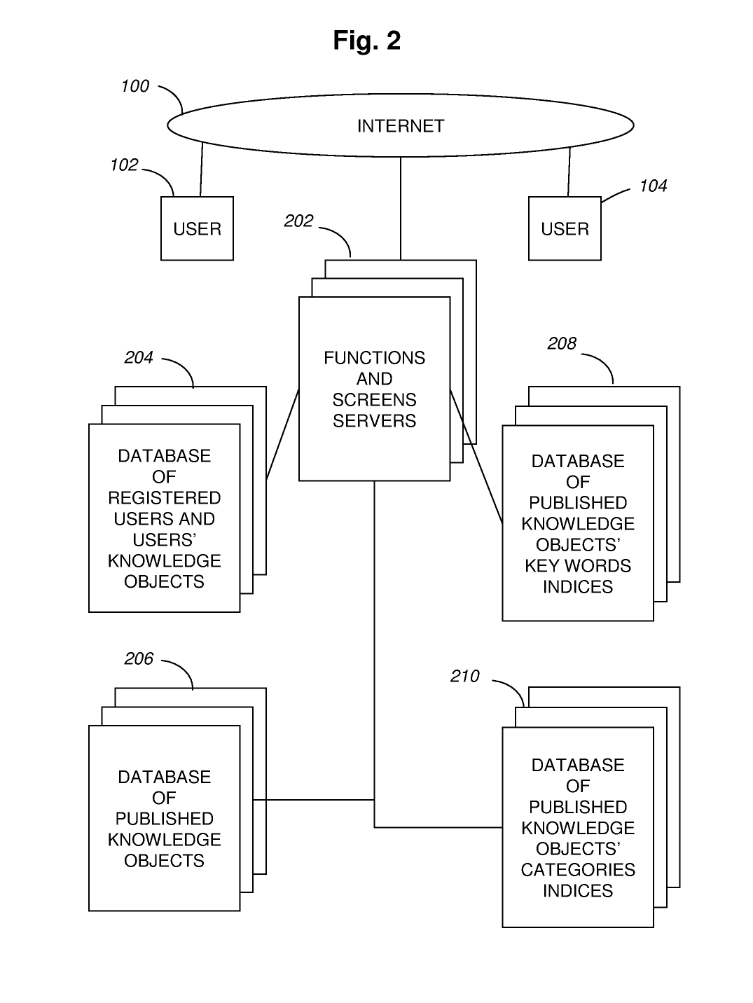

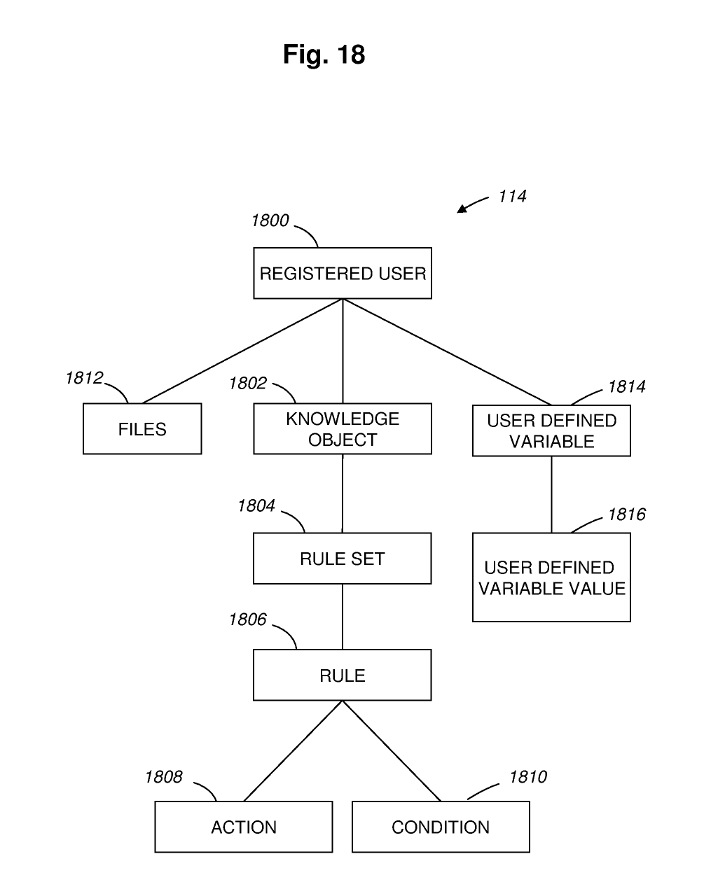

FIG. 1 shows a block diagram of an online system for authoring, publishing and rendering knowledge objects as dynamic interactive web pages in accordance with the present invention. In this example, the system is implemented by programming a network server designated 106. The server 106 is linked to the Internet 100 to service a plurality of users 102, 104. The server 106 has at least one processor 110, random access memory 112, and data storage 108. The data storage 108 contains an array of conventional disk drives. The data storage 108 stores a plurality of programs, databases, and files, including programs for various functions 122, display screens 124, a registered users' database 114, and a published knowledge objects database 116. The registered users' database 114 contains a plurality of registered users and is composed of a number of logical segments and files 1812 as shown in FIG. 18. The logical segments are registered users 1800, knowledge objects 1802, rule sets 1804, rules 1806, actions 1808, conditions 1810, user defined variables 1814, and user defined variable's values 1816. FIG. 1 is the preferred embodiment of an online system for authoring, publishing, and rendering knowledge objects as dynamic interactive web pages when the number of items in databases 114 and 116 is low, and when the number users simultaneously accessing the system 106 is low. It is possible that the online system for authoring, publishing and rendering knowledge objects and its associated databases can be exceeded by the number of simultaneous users and by the number of items stored in the database. In this case, the functions, screen displays and the database services may be spread over a plurality of servers as shown for example in FIG. 2.

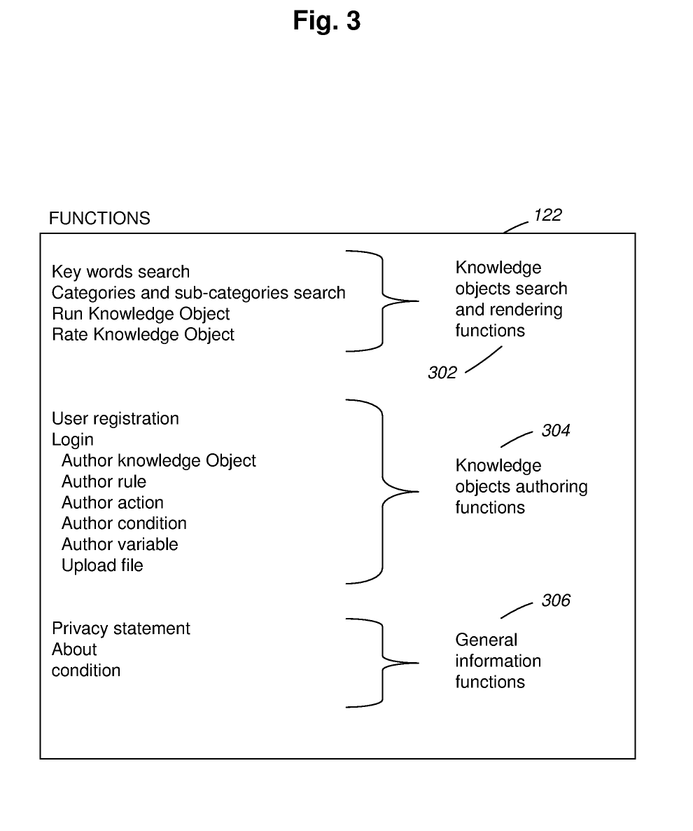

FIG. 2 shows a block diagram of an online system for authoring, publishing, and rendering knowledge objects as dynamic interactive web pages spread over a plurality of servers. This is a preferred embodiment when the number of items stored in the databases 114 and 116 is large, and when the number of simultaneous users accessing the system 106 is large. Each server has a random access memory (RAM) and a plurality of processors. The functions and screens 202 are spread over a plurality of servers to accommodate an increasing number of simultaneous users. Further more, functions and screens may be divided between functions and screens to service knowledge objects' search and rendering functions 302 in FIG. 3, and functions and screens to service knowledge objects' authoring functions 304 in FIG. 3. To accommodate increasing data storage, the database of registered users 114 and the database of published knowledge objects 116 may reside in separate servers and each may be spread over multiple servers. For example, the database of registered users and their knowledge objects may be hosted in servers 204, and the database of published knowledge objects may be hosted in servers 206. Further more, the published knowledge object database may be split into a database of published knowledge objects' key words indices spread over servers 208 to speed the key word search function, and into a database of knowledge objects' categories indices over servers 210 to speed the categories and sub-categories search function. The database of knowledge objects 204 may be spread over a plurality of servers based on, for example, a user's identification. The database of published knowledge objects 206 may be spread over a plurality of servers based on, for example, a user's identification. The database of published knowledge objects' key words indices 208 may be spread over a plurality of servers based on, for example, a key word alphabetic order. The database of knowledge objects' categories indices 210 may be spread over a plurality of servers based on, for example, the knowledge objects categories. A person skilled in the art will notice that there can be a plurality of server configurations between the single server's configuration of FIG. 1 and the multiple servers' configuration of FIG. 2. The configuration of servers is largely dictated by the volume of items stored in a system's database and by the volume of simultaneous users accessing a system. Therefore the server configurations depicted in FIG. 1 and FIG. 2, for an online system for authoring, publishing, and rendering knowledge objects, are for illustrative purposes and should not limit the scope and spirit of this invention.

FIG. 3 shows an outline of the functions 122 provided by the online system for authoring, publishing and rendering knowledge objects. The functions 122 are divided between knowledge objects' search and rendering functions 302, knowledge objects authoring functions 304, and general information functions 306.

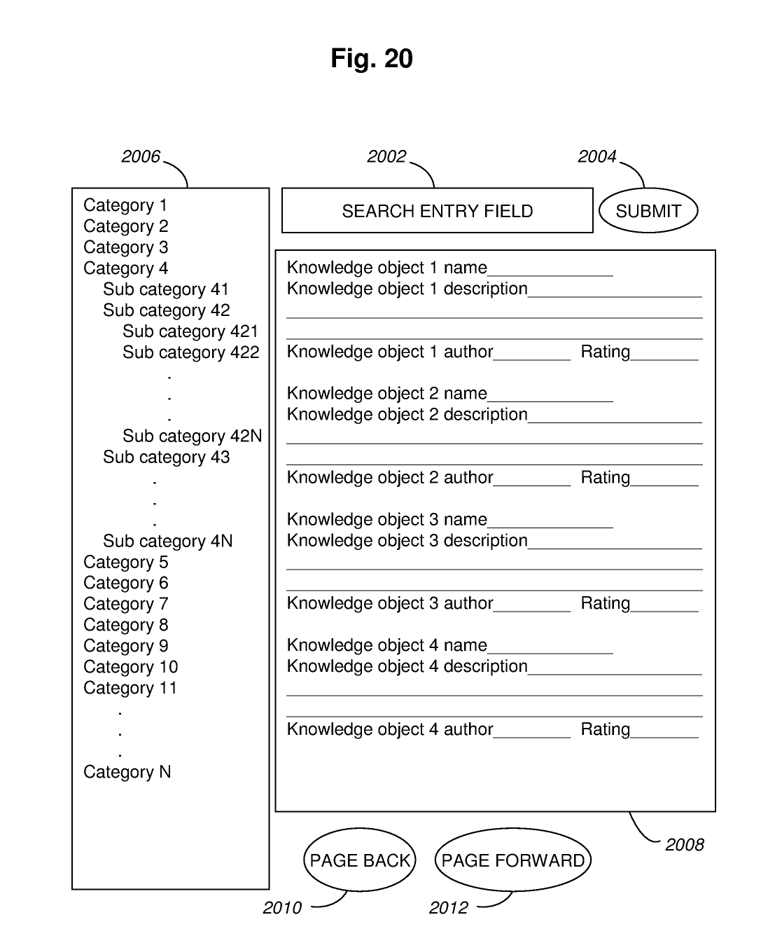

The “Key words search” function allows a user to search the published knowledge objects database by entering words in the search entry field 2002 of FIG. 20 and pressing the submit button 2004. The system accepts words entered by the user, matches the accepted words with words in the published knowledge objects, and returns to the user a list of web page links associated with knowledge objects 2008, whose information matched the entered key words. The “Categories and sub-categories search” function displays a list of published knowledge objects belonging in the category or the sub-category chosen by the knowledge object's author. To choose a category or a sub-category, a user selects a category or sub-category link. Category and sub-category links are displayed in item 2006 of FIG. 20.

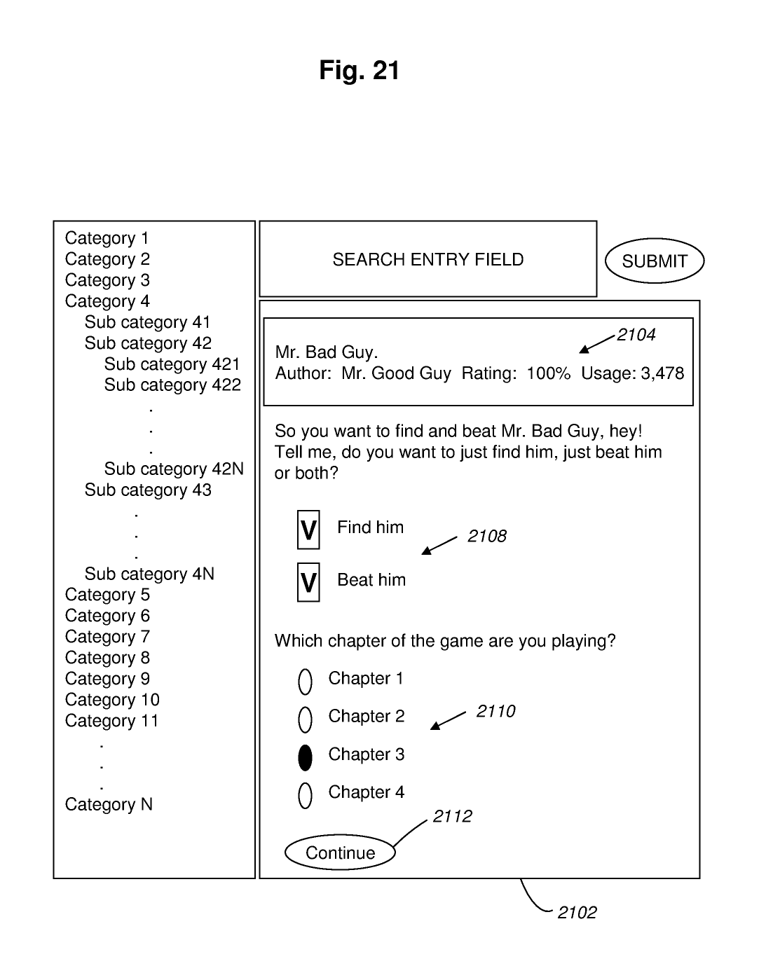

The “Run knowledge object” function renders an instance of a knowledge object as a dynamic interactive web page. Rendering of a knowledge object may be triggered by a user selecting a web page link associated with a knowledge object in the list of web page links 2008, or may be triggered by user recalling a previously saved web page link. In this example, selecting a web page link associated with knowledge object causes the list of web page links 2008 to be replaced by the rendering of an instance of the selected knowledge object as shown for example by item 2102 in FIG. 21.

The “Rate knowledge object” function is provided when a knowledge object's instance has been rendered, than feedback is allowed by the user having experienced the said knowledge object instance. The feedback consists of a rating according to a scale. The composite rating of all users having experienced a knowledge object instance will be visible to other users

The “User registration” function accepts entry of user information. Upon successful completion of the “User registration” function, a user may login and be authenticated by the system.

The “Login” function accepts entry of a user id and password, in order to provide user authentication and access to the knowledge objects' authoring functions 304. Non authenticated users only have access to the knowledge objects' search and rendering functions 302, and access to general information functions 306.

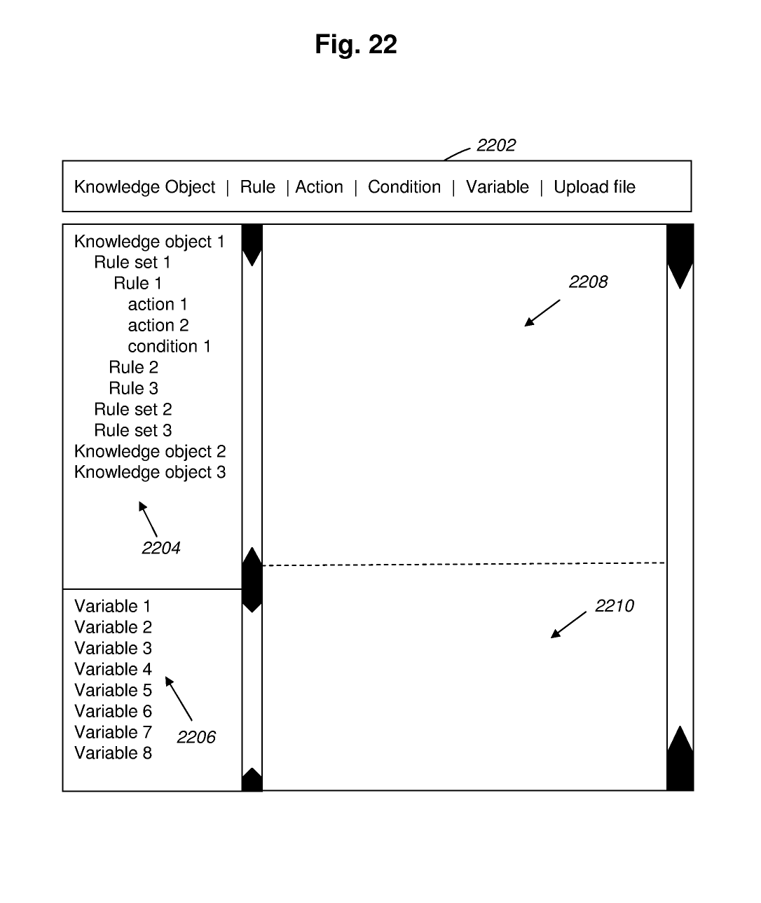

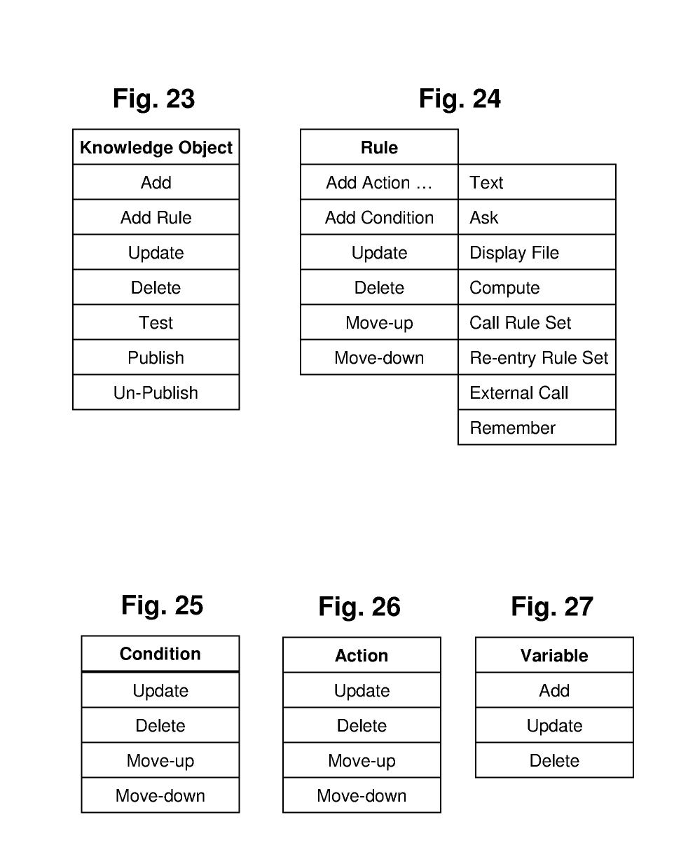

The knowledge objects authoring functions 304 are provided in a screen divided in four areas as shown for example in FIG. 22. The first area of the screen is a tool bar 2202 with drop-down menus with which a user may invoke functions on a knowledge object as shown for example in FIG. 23, functions on a rule as shown for example in FIG. 24, functions on a condition as shown for example in FIG. 25, functions on an action as shown for example in FIG. 26, and functions on a variable as shown for example in FIG. 27. The second area 2204 is composed of a list of knowledge object names and the names, in a hierarchy, of subordinate objects such as rule sets, rules, actions, and conditions. A user's knowledge objects reside on the first level of the list 2204, rule sets are on the second level, next are rules on the third level, and next are actions and conditions on the fourth level. The third area 2206 is composed of a list of user's variable objects. The fourth area 2208 is used to display detailed information about a selected object residing in the screen area 2204, or residing in the screen area 2206. The screen area 2208 is also use to display the control buttons necessary for a user to perform authoring functions upon the selected object.

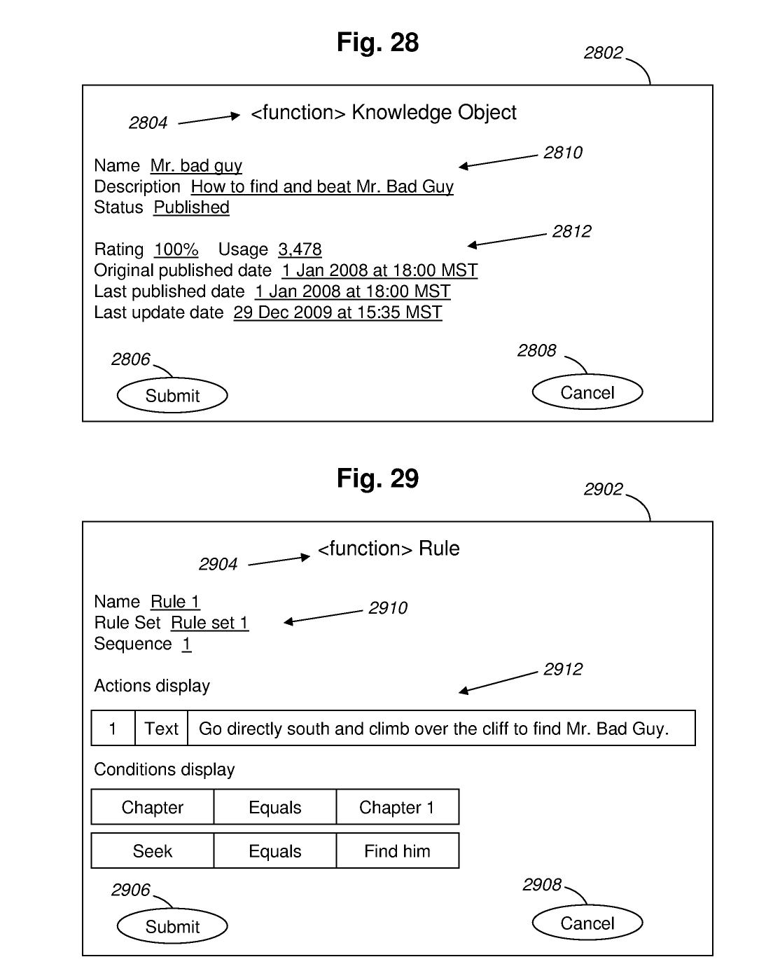

The “Author knowledge object” function provides a way for the user to add, update, test, delete, publish and un-publish a knowledge object. A first time user, having no knowledge object, may invoke the add function by selecting the add option, as shown for example in FIG. 23, of the knowledge object menu of the tool bar 2202. Upon invocation of the add function, the system provides a screen, as shown for example in FIG. 28, allowing the user to enter the knowledge object's detailed information 2810, and a submit button 2806 allowing the user to complete the add function. Upon successfully adding a knowledge object, the knowledge object's name is added to the list of knowledge object names in the screen area 2204. When a user selects a knowledge object's name in the screen area 2204, the system displays the selected knowledge object's detail information in the screen area 2208, and enables the update, delete, test, publish if not published, un-publish if published, and add rule options of the knowledge object's menu. The user may update, delete, publish, and un-publish a selected knowledge object by selecting the corresponding function in the knowledge object menu, as shown for example in FIG. 23, and pressing the submit button 2806 displayed as a result of the function invocation. Invoking the test option will render the knowledge object in the screen area 2208, as shown for example by item 2102 of FIG. 21. When the test function is invoked, a screen area 2208 shrinks from the bottom to make place to a new screen area 2210. In the screen area 2208, the user experiences a running instance of the selected knowledge object where text, pictures, entry fields, choice selections, and a continue button may be displayed enabling the user to enter into a back and forth conversation with the running instance of the knowledge object. In the screen area 2210, the user may follow a trace of the execution of the knowledge object by following the ordered listing of invoked rules with fulfilled conditions, and the ordered listing of actions performed.

The “Author rule” function provides a way for a user to add, update, order, and delete a rule. A first time user, having no rule, may invoke the add function by selecting the add rule option, as shown for example in FIG. 23, of the knowledge object menu of the tool bar 2202. Upon invocation of the add function, the system provides a screen, as shown for example in FIG. 29, allowing the user to enter the rule's detailed information 2910, and a submit button 2906 allowing the user to complete the add function. Upon successfully adding a rule, the rule's name is added under and indented from the selected knowledge object name in the screen area 2204. When a user selects a rule's name in the screen area 2204, the system displays the selected rule's detail information in the screen area 2208, and enables the update, delete, move-up, move-down, add action, and add condition options of the rule's menu. The user may update, and delete a selected rule by selecting the corresponding function in the rule menu, as shown for example in FIG. 24, and pressing the submit button 2906 displayed as a result of the function invocation.

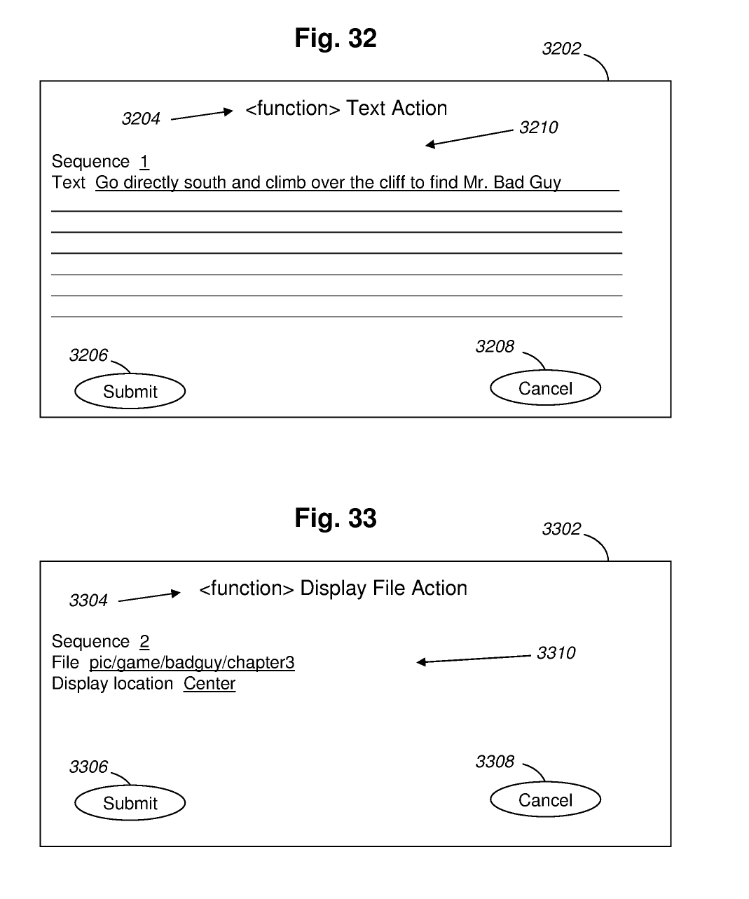

The “Author action” function provides a way for a user to add, update, order, and delete an action. A first time user, having no action, may invoke the add function by selecting the add action option, as shown for example in FIG. 24, of the rule menu on the tool bar 2202. Upon invocation of the add function, the system provides a screen, as shown for example in FIG. 32, allowing the user to enter the action's detailed information 3210, and a submit button 3206 allowing the user to complete the add function. Upon successfully adding an action, the action reference is added under and indented from the selected rule name in the screen area 2204. When a user selects an action's reference in the screen area 2204, the system displays the selected action's detail information in the screen area 2208, and enables the update, delete, move-up, and move-down options of the action's menu. The user may update, and delete a selected action by selecting the corresponding function in the action menu, as shown for example in FIG. 26, and pressing the submit button 3206 displayed as a result of the function invocation. The “Author condition” function provides a way for a user to add, update, order, and delete a condition. A first time user, having no condition, may invoke the add function by selecting the add condition option, as shown for example in FIG. 24, of the rule menu of the tool bar 2202. Upon invocation of the add function, the system provides a screen, as shown for example in FIG. 31, allowing the user to enter the condition's detailed information 3110, and a submit button 3106 allowing the user to complete the add function. Upon successfully adding a condition, the condition's reference is added under and indented from the selected rule name in the screen area 2204. When a user selects a condition's reference in the screen area 2204, the system displays the selected condition's detail information in the screen area 2208, and enables the update, delete, move-up, and move-down options of the condition's menu. The user may update, and delete a selected condition by selecting the corresponding function in the condition menu, as shown for example in FIG. 25, and pressing the submit button 3106 displayed as a result of the function invocation.

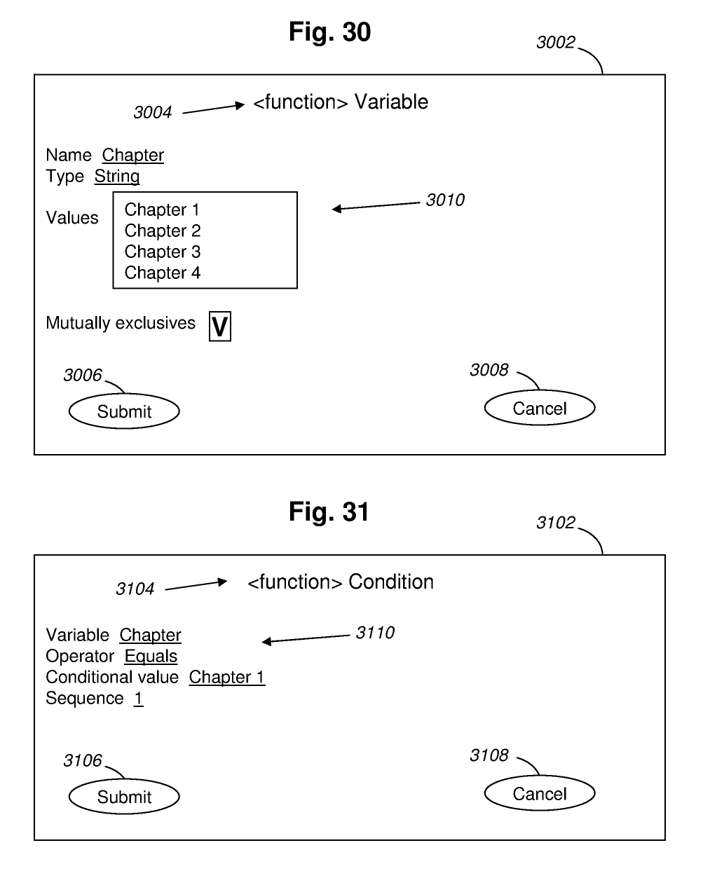

The “Author variable” function provides a way for a user to add, update, and delete a variable. A first time user, having no variable, may invoke the add function by selecting the add option, as shown for example in FIG. 27, of the variable menu of the tool bar 2202. Upon invocation of the add function, the system provides a screen, as shown for example in FIG. 30, allowing the user to enter the variable's detailed information 3010 including the variable's potential values, and a submit button 3006 allowing the user to complete the add function. Upon successfully adding a variable, the variable's name is added to the list of variable names in the screen area 2206. When a user selects a variable's name in the screen area 2206, the system displays the selected variable's detail information in the screen area 2208, and enables the update and delete options of the variable's menu. The user may update and delete a selected variable by invoking the corresponding option in the variable menu, as shown for example in FIG. 27, and pressing the submit button 3006 displayed as a result of the function invocation.

The “Upload file” function provides a way for a registered user to transfer a copy of a file, stored locally on the user's personal computer, to the data storage 108 on a disk file system, 1812 of FIG. 18, reserved for the registered user.

The “Privacy statement” function displays a screen to the user informing the user that the user's information and the user's knowledge objects are kept on a secure database and are not passed to any unaffiliated third party unless disclosed and authorized by the user.

The “About” function displays a screen to the user informing the user about services provided by the system for authoring and publishing knowledge objects.

The “condition” function displays a screen informing the user of allowable and disallowable contents for knowledge objects.

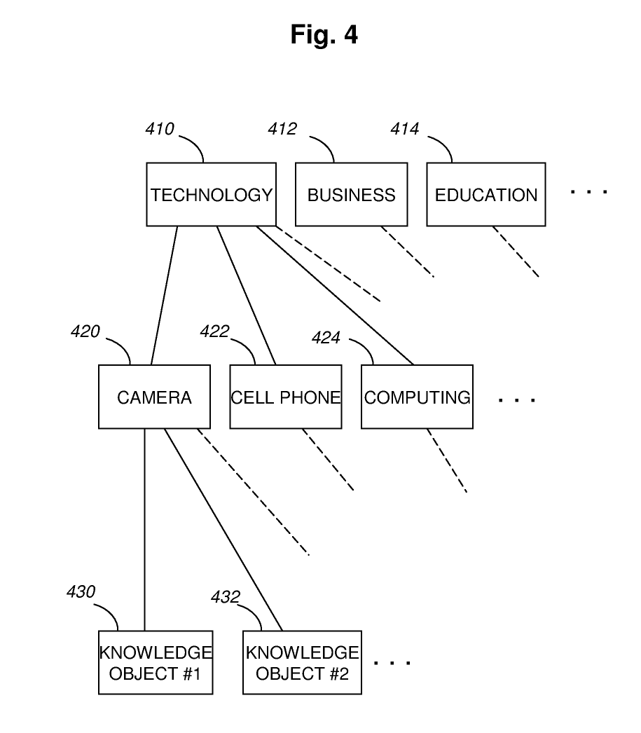

FIG. 4 shows a block diagram of examples of knowledge objects categories 410, 412, and 414, sub-categories 420, 422, and 424, and knowledge objects 430, 432 categorized under a sub-category. A knowledge object may belong to a category, a sub-category, a plurality of categories, a plurality of sub-categories, or have no category at all. There is no limit on the number of sub-category levels. The sub-category camera 420 may have, for example, its own sub-categories of digital camera, film camera, and antique camera. The categorization and sub-categorization of knowledge objects allows a user to search knowledge objects based on area of interest organized into categories and sub-categories.

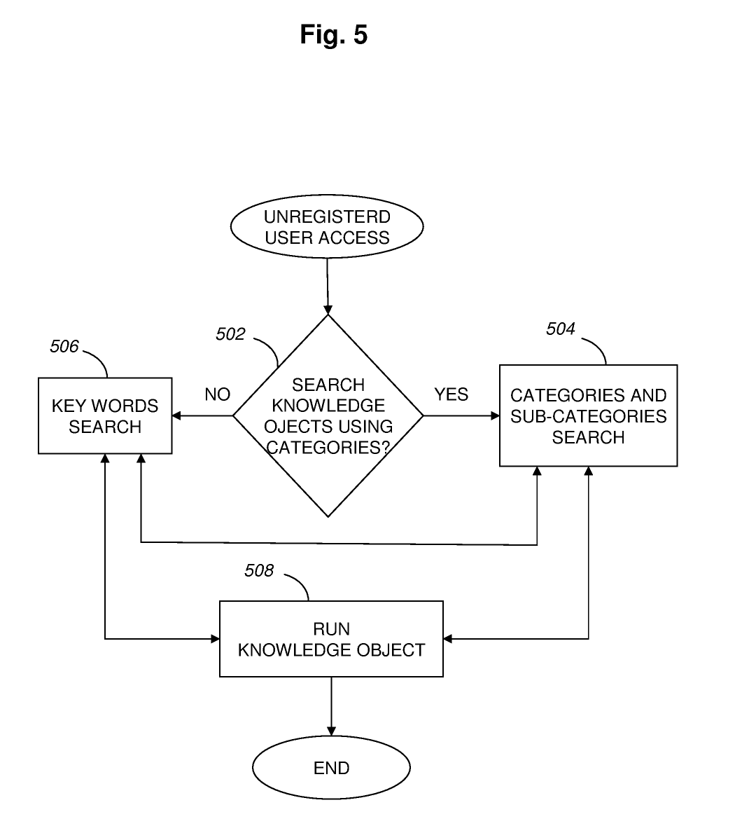

FIG. 5 shows a flowchart of a typical sequence of an unregistered user access of the system for authoring, publishing and rendering knowledge objects as dynamic interactive web pages. The actual sequence of user access may vary from that shown in FIG. 5, because the user may access the various functions of the system as desired and as needed. For example, the user may access a previously saved search instead of starting a new one, or the user may login and author the user's knowledge objects.

In step 502 of FIG. 5, execution branches to step 506 if the user would like to search the database of published knowledge object by using a key word search method. Execution branches to step 504 if the user would like to search the database of published knowledge object by exploring the categories and sub-categories of published knowledge objects.

In step 506, the system accepts words, entered by a user in the search field 2002 of FIG. 20, accepts the search command, triggered by the user by pressing the submit button 2004, searches the database of published knowledge objects matching knowledge objects' key words with the user entered words, and displays a list of web page links (URLs) associated with published knowledge objects, related to the key words entered, on the web page area 2008. If the list of web page links displayed is too long for the screen, a scroll bar and paging controls 2010, 2012 are enabled and displayed on the page area 2008. A user pressing the submit button 2004 causes the system to collapse the display of the category and sub-category list to only the categories and sub-categories containing knowledge objects whose key words match the user entered key words, with each category and sub-category displaying the number of related knowledge objects contained in that category or sub-category. The user may scroll down or use the paging controls 2010, 2012 to browse at more knowledge objects. Execution may continue from step 506 to step 504 if the user selects a category or a sub-category 2006 to further restrict the number of knowledge objects references shown on the web page area 2008 to only those related to the key words entered and belonging to the category or sub-category selected. The user may use several combinations of key word search and category and sub-category selection until the desired knowledge object is found. Once the desired knowledge object is found, execution continues from step 506 to step 508.

In step 504, the system accepts a category or a sub-category 2006 selection, selected by a user, and displays a list of web page links (URLs) associated with published knowledge objects belonging to the category or sub-category selected, as shown for example, in the web page area 2008. If the list of web page links displayed is too long for the page area 2008, a scroll bar and paging controls 2010, 2012 are enabled and displayed on the page area 2008. The user may scroll down or use the paging controls 2010, 2012 to browse at more knowledge object references. Execution may continue from 504 to step 506 if the user enters key words in the search field 2002 and presses the submit button 2004 to further restrict the number of knowledge object references shown on the web page area 2008 to only those related to the key words entered and belonging to the category or sub-category selected. The user may use several combinations of key word search and category and sub-category selection until the desired knowledge object is found. Once the desired knowledge object is found, execution continues from step 504 to step 508.

In step 508, the system accepts a web page request, triggered by the user by selecting a web page link (URL) associated with a knowledge object from the list of published knowledge object references displayed by step 504 or by step 506 or by a combination of steps 504 and 506, loads an instance of the desired the knowledge object in memory RAM 112, and renders the knowledge object as a dynamic interactive web page, for example, on the page area 2102 of FIG. 21. During a session between a user 102 and the online system 106, the system loads an instance of a knowledge object in the random access memory 112 and associates the loaded knowledge object with the user 102. The invocation and running of a knowledge object instance causes a list of variable value pairs to be created, either by the knowledge object instance's actions or by the user responding to questions prompted by the knowledge object's instance, to be loaded in the random access memory 112, and to be associated with the user's session.

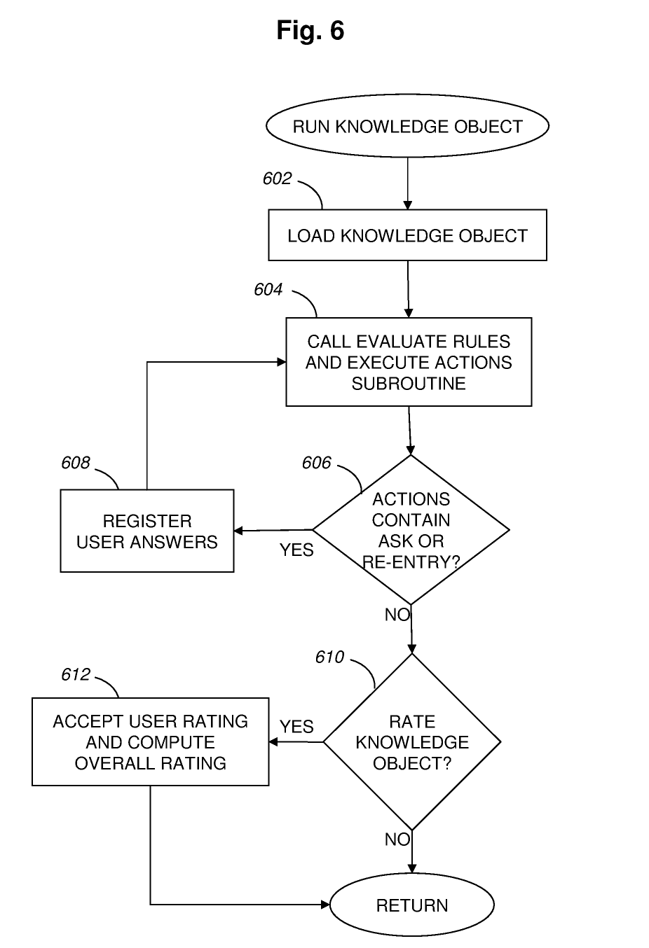

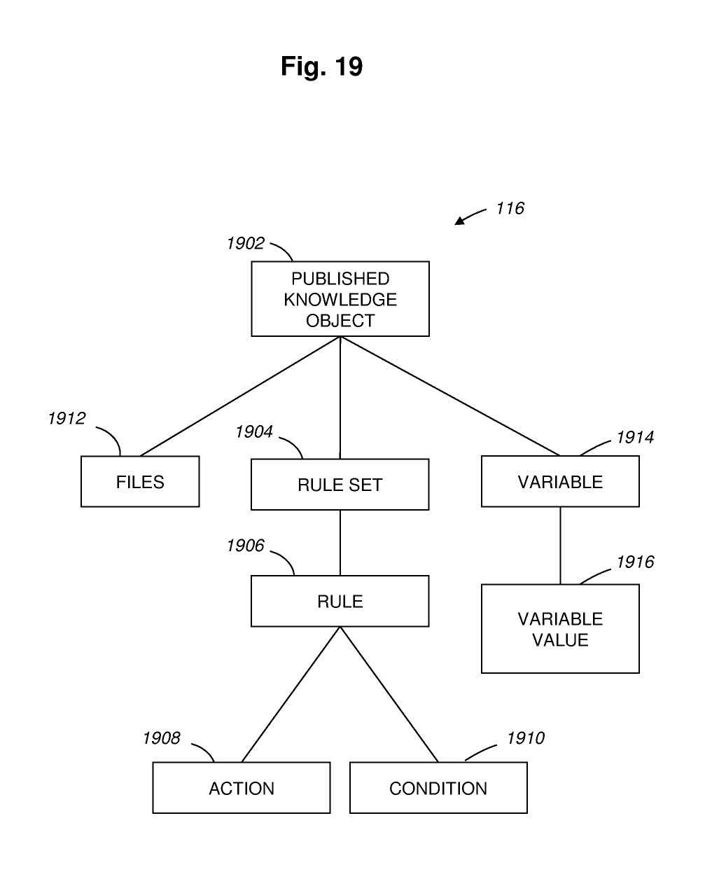

Henceforth, a knowledge object's instance, residing in RAM 112, composed of a knowledge object 1902 of FIG. 19, with a set of rule sets 1904, with each rule set having a set of rules 1906, with each rule having a plurality of actions 1908 and a plurality of conditions 1910, with a plurality of variables 1914, with each variable having a plurality of variable values 1916, invoked by and associated to a user' session will be referred to as a Knowledge Object Instance. Henceforth, the list of variable value pairs associated with a user' session and residing in RAM 112 will be referred to as a User List of Variable Value Pair. The procedure and steps to load and render an instance of a selected knowledge object is further detailed in FIG. 6. Once the user has experienced an instance of the knowledge object, execution may continue to step 506 if the user wants to search for more published knowledge objects by using key words, or execution may continue to step 504 if the user wants to search for more published knowledge objects by using categories and sub-categories, or execution may end.

FIG. 6 shows a flow chart of a user experiencing an instance of a knowledge object within the run knowledge object step 508 in FIG. 5.

In step 602 of FIG. 6, the system reads the user selected knowledge object FIG. 19, and loads the selected knowledge into the server's random access memory, thus creating a Knowledge Object Instance, and executes the Knowledge Object Instance via the server's processor 110. Execution continues from step 602 to step 604.

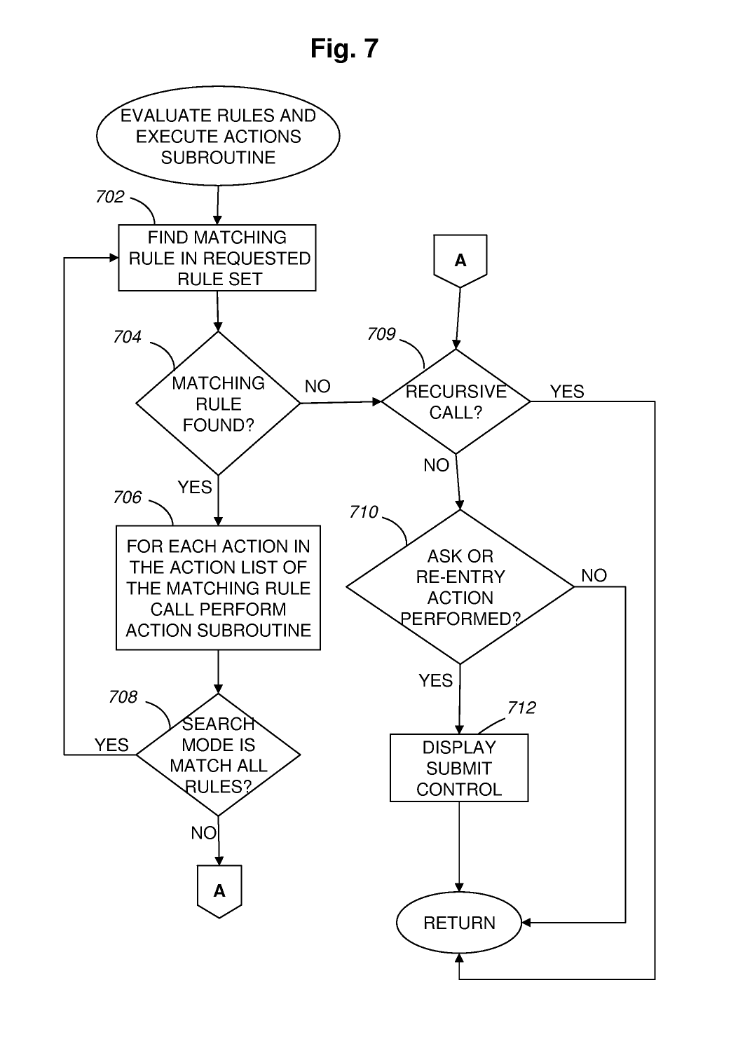

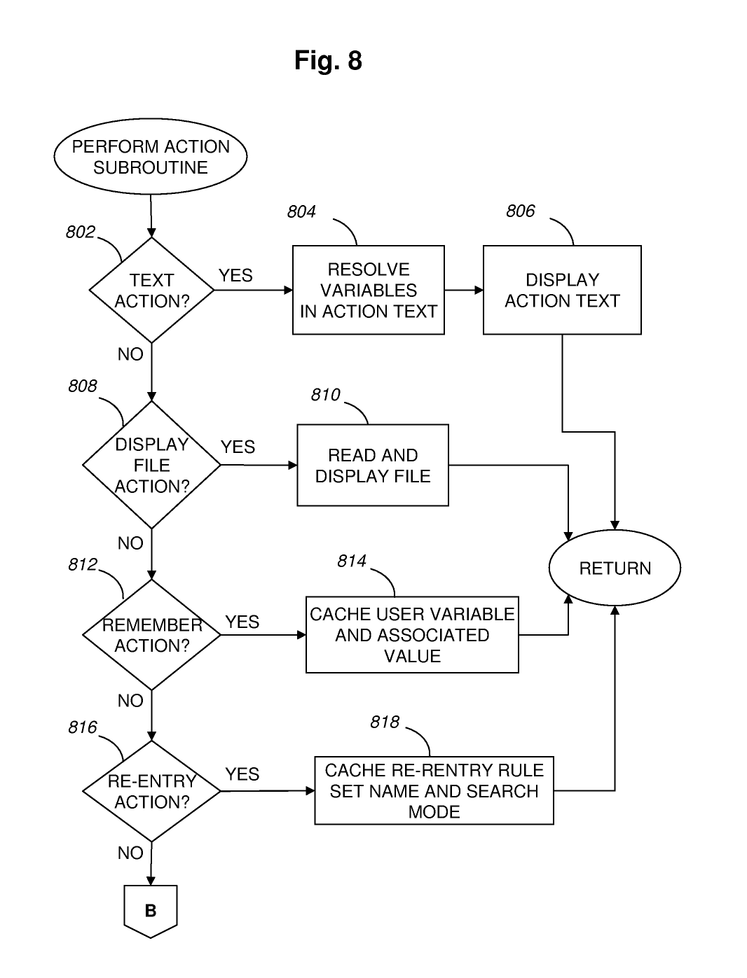

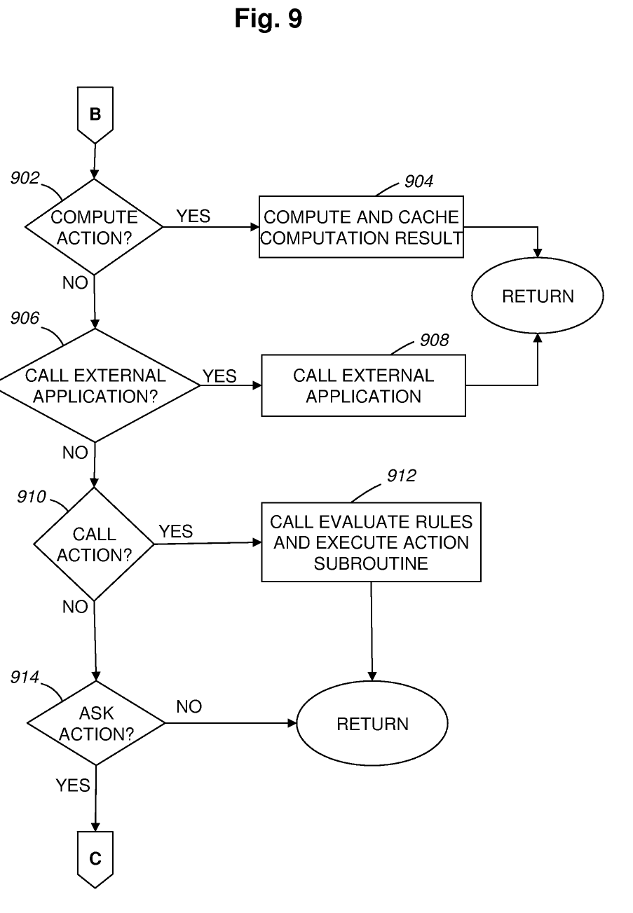

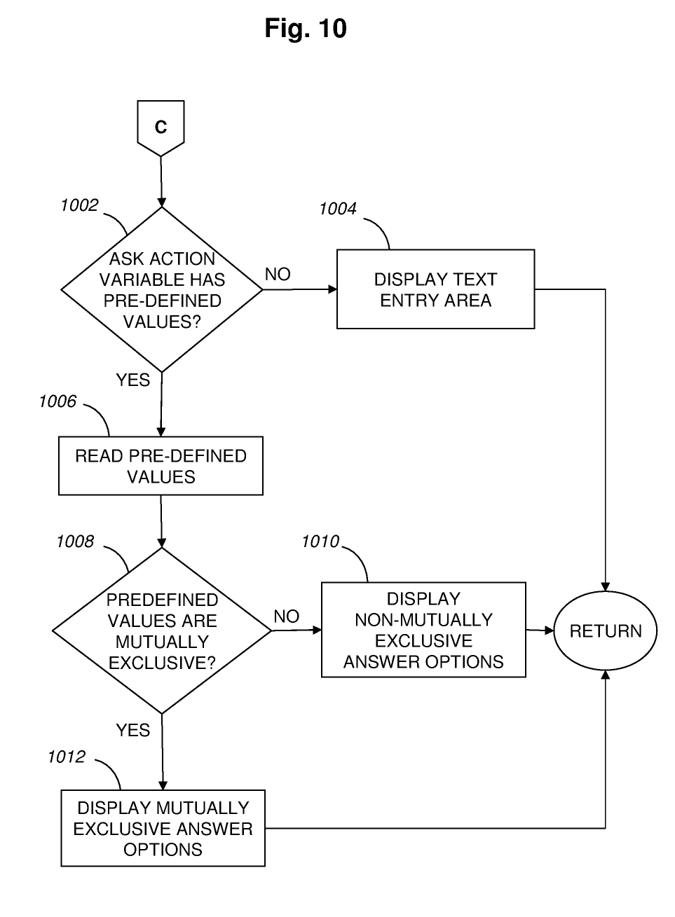

In step 604, the system calls the evaluate rules and execute actions subroutine, further defined in FIG. 7, causing information and questions, if any, to be displayed to the user. An alternative embodiment from immediately executing actions that result in displaying information to the user, as described for illustrative purposes in FIG. 8, FIG. 9, and FIG. 10, is to assemble such actions in a cache, and execute them just prior to leaving this step 604.

In step 606, execution branches to step 608 if the actions executed in step 604 contain at least one ask action or one re-entry action. Otherwise, execution branches to step 610.

In step 608, the system may prompt the user for a continuation generated by a re-entry action and may prompt the user for one or more questions, each question generated by an ask action. The system accepts the user's responses, and updates the User List of Variable Value Pair with the user's responses. The user may answer a question prompted by an ask action by entering text in a data entry field provided by the ask action 1004 in FIG. 10, or the user may answer a question by selecting an answer from a pre-defined mutually exclusive list of answer options provided by the ask action 1012, or the user may answer the question by selecting answers from a pre-defined non-mutually exclusive list of answer options provided by the ask action 1010. How the system chooses to display, based on an ask question, a data entry field, a list of mutually exclusive answer options or a list of non-mutually exclusive answer options is detailed in FIG. 10. The system presents, to the user, a submit button 712 in FIG. 7. Upon receiving the submit button command, execution continues from step 608 to step 604.

In step 610, execution branches to step 612 if the user would like to rate the knowledge object whose instance the user just experienced. Otherwise, execution returns to step 508 of FIG. 5. In step 612, the system accepts the user rating for the rendered instance of a knowledge object and computes an overall rating by adding this rating to, and averaging with previous ratings for that same knowledge object. Execution returns to step 508 of FIG. 5.

FIG. 7 shows a flow chart of a subroutine finding a matching rule and executing the matching rule's actions. This subroutine is called within step 604 of FIG. 6, and is called recursively within step 912 of FIG. 9.

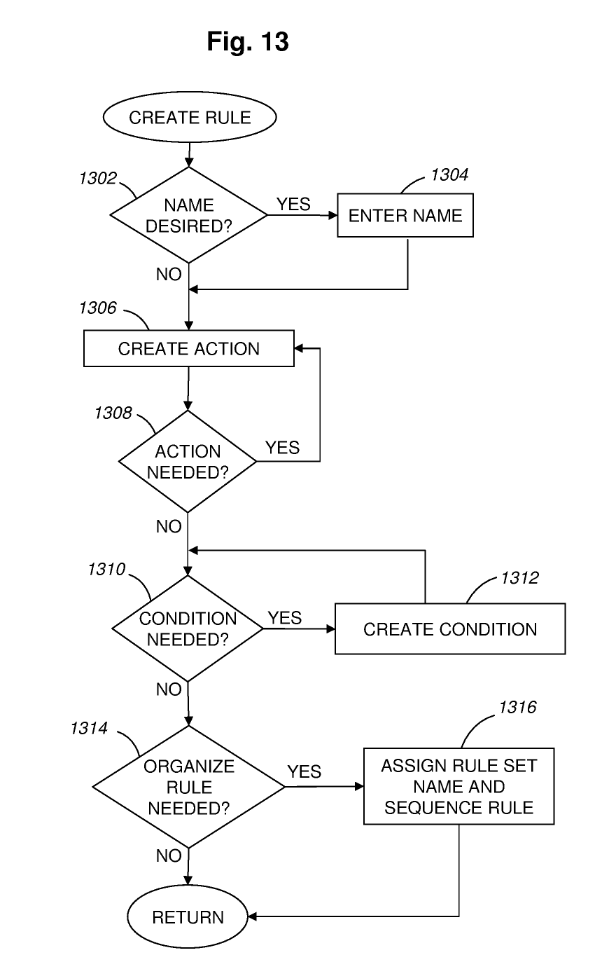

In step 702 of FIG. 7, the system searches for a matching rule in the requested rule set and using the requested search mode. The requested rule set is the Knowledge Object Instance's default rule set unless a re-entry action 818 in FIG. 8 or a call action 912 in FIG. 9 changes the requested rule set name. The requested search mode can either be match the first rule or match all rules. By default, the search mode is set to match all rules unless a re-entry action 818 or a call action 912 changed the search mode. The evaluation order of the rules, within a rule set, is established during the rule creation which is further detailed in FIG. 13. A matching rule is a rule that has all its conditions evaluated to true. A condition is evaluated by first substituting the variables in the condition statement with the variables' value contained in the User List of Variable Value Pair, and than evaluating the left expression with the right expression of the conditional statement against the conditional statement operator. For examples, a condition stating 5 is greater than 1 evaluates to true, and a condition stating 1 is greater than 5 evaluates to false. If one of the rule's condition evaluates to false, than the rule is mark as a non-matching rule and the system continues its search for a matching rule starting with the next rule after the non-matching rule. If all of the rule's conditions evaluate to true, than the system marks the rule as a matching rule and remembers the position of the matching rule within the invoked set of rules. A rule that has no condition is a special case and is marked as a matching rule. Once a matching rule is found, or when the last rule in the invoked set of rules has been visited, execution continues from step 702 to step 704.

In step 704, execution branches to step 709 if a matching rule was not found. Execution branches to step 706 if a matching rule was found.

In step 706, the system repeats calling the perform action subroutine with each action of the matching rule's action list until the end of the matching rule's action list is reached. The actions of the matching rule's action list are read, by the system, in the order indicated by the user when the action was created. The steps and procedure of the perform action subroutine are detailed in FIG. 8, FIG. 9, and FIG. 10. The user skilled in the art will notice that the actions of FIG. 8, FIG. 9, and FIG. 10 immediately display, to a user, displayable information. They do so for illustrative purposes and ease of understanding. An equivalent method is to assemble, in a cache, all the actions resulting into displayable information, and to sequentially execute these actions just prior leaving step 604 called “call evaluate rule and execute actions subroutine”. Execution continues from step 706 to step 708.

In step 708, execution branches to step 702 if the search mode is set to match all rules. Execution branches to step 709 if the search mode is set to match first rule.

In step 709, execution branches to step 710 if the call to the evaluate rules and execute actions subroutine is not a recursive call, that is not called from step 912 of FIG. 9. Otherwise, execution returns to the step who called the evaluate rule and execute actions subroutine, which is step 912 of FIG. 9.

In step 710, execution branches to step 712 if the perform action subroutine, on the current or on a previous execution, performed at least one ask action 1004, 1010 or 1012 of FIG. 10, or performed at least one re-entry action 818 of FIG. 8. Otherwise, execution returns to the step who called the evaluate rule and execute actions subroutine, which is step 604 of FIG. 6.

In step 712, the system displays a submit control button allowing the user to submit the user's answers to the system. The submit control button, tied to an ask action or to a re-entry action, points to a re-entry rule set within a knowledge object and acts as a user selectable reference to a subset of rules within a knowledge object. An example of a submit control button is illustrated by item 2112, on the web page area 2102 of FIG. 21. Execution returns to the step who called the evaluate rule and execute actions subroutine, which is step 604 of FIG. 6.

FIG. 8 is the first sheet of a 3 sheets flow chart—FIG. 8, FIG. 9, and FIG. 10—showing how the system performs an action within the call perform action subroutine in step 706 in FIG. 7. Some of the actions described in FIG. 8, FIG. 9, and FIG. 10 generate web page components such as, for example, the text, display file, re-entry and ask actions. For illustration purposes in these diagrams, actions immediately display objects presented to a user. An equivalent embodiment is be to delay these actions so that they are executed just before exiting the call evaluate rules and execute actions subroutine step 604 of FIG. 6.

In step 802 of FIG. 8, execution branches to step 804 if the action is a text action. Otherwise execution branches to step 808.

In step 804, the system substitutes the variables if any, found in the text of the text action, with their corresponding run-time value found in the User List of Variable Value Pair. Execution continues from step 804 to step 806.

In step 806, the system displays the text of the action text to the user, illustrated for example in the web page area 2102. Step 806 is an example of generating a web page component. Execution returns to the step who called the perform action subroutine.

In step 808, execution branches to step 810 if the action is a display file action. Otherwise execution branches to step 812.

In step 810, the system reads the file 1912 identified by the display file action, identifies the type of file (e.g. text, image, sound, movie, etc. . . . ) and renders the file to the user, for example in the web page area 2102. Step 810 is another example of generating a web page component. Execution returns to the step who called the perform action subroutine.

In step 812, execution branches to step 814 if the action is a remember action. Otherwise execution branches to step 816.

In step 814, the system reads the variable and its corresponding value from the remember action, creates a variable value pair, and caches it in the User List of Variable Value Pair. Execution returns to the step who called the perform action subroutine.

In step 816, execution branches to step 818 if the action is a re-entry action. Otherwise execution branches to step 902 of FIG. 9.

In step 818, the system reads the re-entry rule set name and the re-entry search mode from the re-entry action, and caches the read rule set name and the search mode in the Knowledge Object Instance for the next user invocation in that user's session. Alternatively, the system may send, to the user, the re-entry rule set name and the re-entry search mode as non-displayable information along with the sent displayable information in such a way that this information is returned to the system when the user presses a submit button. Step 818 is an example of generating a user selectable reference to a subset of the plurality of rules. Execution returns to the step who called the perform action subroutine.

In step 902 of FIG. 9, execution branches to step 904 if the action is a compute action. Otherwise execution branches to step 906.

In step 904, the system reads the result variable name and the formula expression from the compute action, substitutes any variables found in the formula expression, computes the result of the formula, creates a variable value pair with the variable name and formula's result, and caches it in the User List of Variable Value Pair. Step 904 is an example of generating a variable value pair, wherein said value is set according to the evaluation of a formula. Execution returns to the step who called the perform action subroutine.

In step 906, execution branches to step 908 if the action is a call external application action. Otherwise execution branches to step 910.

In step 908, the system reads an external application address and a call method from the call external action, calls the external application passing the variables and values pairs residing in the User List of Variable Value Pair, and upon return from the external application, updates the User List of Variable Value Pair with variable and value pairs returned by the external application. Step 908 is an example of calling an independent computer implemented system. Execution returns to the step who called the perform action subroutine.

In step 910, execution branches to step 912 if the action is a call action. Otherwise execution branches to step 914.

In step 912, the system reads the rule set name, the search method and the iterative indicator from the call action, and calls the evaluate rules and execute actions subroutine passing the read rule set name and search method. The call to the evaluate rules and execute actions subroutine is an example of an invocation of a subset of the plurality of rules. Once execution returns from the evaluate rules and execute actions subroutine, the call to the evaluate rules and execute actions subroutine is repeated only if the iterative indicator is on and until the evaluate rules and execute actions subroutine finds no matching rules. Execution returns to the step who called the perform action subroutine. The call, from step 912, to the evaluate rules and execute actions subroutine is a recursive call which creates a new instance of the evaluate rules and execute actions subroutine while keeping the state of the previous instance of the said subroutine intact. Once the new subroutine is completed, execution returns to the previous subroutine at a place right after its recursive call.

In step 914, execution branches to step 1002 of FIG. 10 if the action is an ask action. Otherwise, execution returns to the step who called the perform action subroutine.

In step 1002 of FIG. 10, execution branches to step 1004 if the variable of the ask action does not have pre-defined values. Execution branches to step 1006 if the variable of the ask action has pre-defined values.

In step 1004, the system displays a text entry field as a user input component, for example in the web page area 2102, for the user to enter the user's response to the ask action. Execution returns to the step who called the perform action subroutine.

In step 1006, the system reads the ask action variable from the ask action, and reads the variable's pre-defined values from the Knowledge Object Instance. Execution continues from step 1006 to step 1008.

In step 1008, execution branches to step 1010 if the variable's defined values are not mutually exclusives. Execution branches to step 1012 if the variable's defined values are mutually exclusives.

In step 1010, the system displays the options of a non-mutually exclusive user selection component using the pre-defined values of the ask action variable read in step 1006. An example of a non-mutually exclusive user selection component display may be a checkbox grouping where a user may select multiple choices. An example of a non-mutually exclusive option is shown in drawing 2108 of FIG. 21. Execution returns to the step who called the perform action subroutine.

In step 1012, the system displays the options of a mutually exclusive user selection component using the pre-defined values of the ask action variable read in step 1006. An example of a mutually exclusive user selection component display may be a radio button grouping where a user may select only one choice. Another example of a mutually exclusive options display may be a grouping of links, each link pointing to a separate rule set within a knowledge object thus creating a user selectable reference to subsets of rules within said knowledge object. An example of a mutually exclusive option is shown in drawing 2110 of FIG. 21. Execution returns to the step who called the perform action subroutine.

FIG. 11 shows a flow chart of a typical sequence of a registered user's access to the system of authoring, publishing and rendering knowledge objects as dynamic interactive web pages for the purpose of authoring the user's knowledge objects. The actual sequence of user access may vary from that shown in FIG. 11, because the user may access the various functions of the system as desired and as needed.

In step 1102 of FIG. 11, execution branches to step 1104 if the user is new to the authoring, publishing and rendering knowledge objects system. Otherwise execution branches to step 1106.

In step 1104, the system registers the user by assigning a unique user identification number, by obtaining, from the user, a user name, a user password, and a user email address, and by saving the information obtained from the user in the registered user logical segment 1800 of FIG. 18. Execution continues from step 1104 to step 1106.

In step 1106, the system authenticates a user by obtaining, from the user, a user name and a user password, and by comparing the user password with the saved user password for that user's name in the registered user' logical segment 1800. Once a user is authenticated, execution continues from step 1106 to step 1108.

In step 1108, execution branches to step 1110 if the user wants to author its knowledge objects. Otherwise, execution branches to step 502 of FIG. 5.

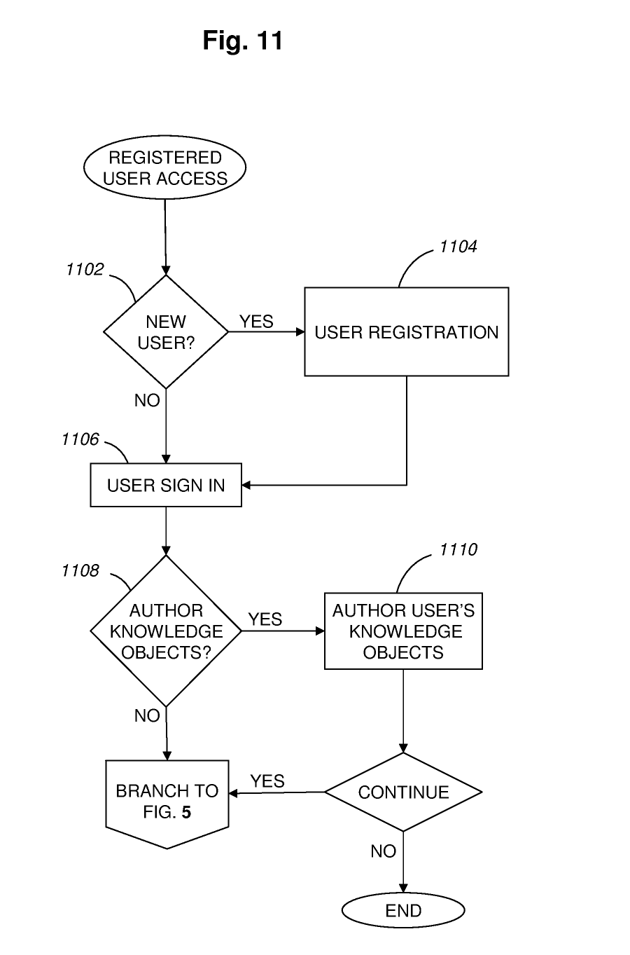

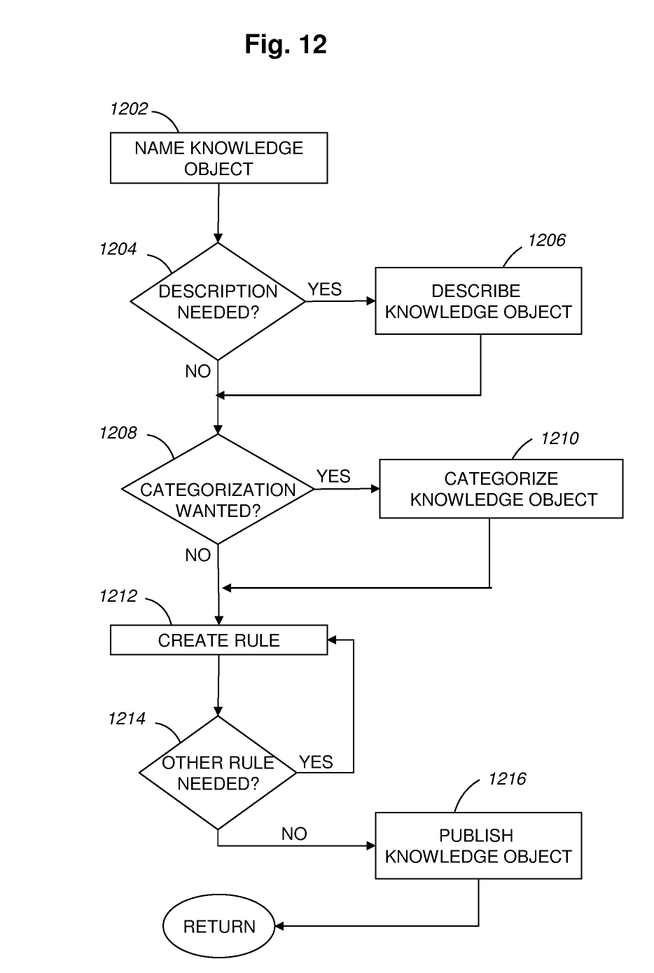

In step 1110, the system presents a screen FIG. 21, to the user, containing the user's knowledge objects, if any, and makes available the functions for the user to add, update, inspect, test, publish, un-publish, and delete the user's knowledge objects. The procedure and steps to access and perform particular authoring functions are detailed in FIG. 21 through FIG. 38. The procedure and steps to add a knowledge object are detailed in FIG. 12 through FIG. 17. Once a user completes the authoring of its knowledge objects, execution may continue to step 502 of FIG. 5 or execution may end.

FIG. 12 shows a flow chart of a registered user creating a knowledge object within the “Author user's knowledge objects” procedure of FIG. 11.

In step 1202 of FIG. 12, the system accepts a knowledge object name entered by the user, and writes the knowledge object's name in the knowledge object logical segment 1802 of FIG. 18. Execution continues from step 1202 to step 1204.

In step 1204, execution branches to step 1206 if the user would like to enter a description for the knowledge object. Otherwise execution branches to step 1208.

In step 1206, the system accepts a knowledge object description entered by the user, and writes the knowledge object's description in the knowledge object logical segment 1802. Execution continues from step 1206 to step 1208.

In step 1208, execution branches to step 1210 if the user would like to classify the knowledge object in one or more categories or sub-categories. Otherwise execution branches to step 1212.

In step 1210, the system accepts one or more knowledge object category or sub-category selected by the user, and writes the knowledge object's categories and sub-categories in the knowledge object logical segment 1802. Execution continues from step 1210 to step 1212.

In step 1212, the system accepts a rule entered by the user; writes the rule set name, associated with the rule, to the rule set logical segment 1804 of FIG. 18, writes the rule to the rule logical segment 1806, writes the actions to the action logical segment 1808, writes the conditions, if any, to the condition logical segment 1810, writes the variables, if any, to the user defined variable logical segment 1814, and writes the variables' associated values, if any, to the user defined variable value logical segment 1816. In one embodiment, as described in FIG. 13 through FIG. 17, the system caches each component of a rule, entered by the user, in a memory buffer RAM allocated for a rule creation, and writes at once the logical segments of FIG. 18 associated with each component of a rule. In another embodiment, as described in FIG. 22 through FIG. 39, the system writes the logical segments of FIG. 18 as each component of the rule is entered by the user. The steps and procedure to create a rule are further defined in FIG. 13. Execution continues from step 1212 to step 1214.

In step 1214, execution branches back to step 1212 if the user would like to create another rule. Otherwise execution branches to step 1216.

In step 1216, a user may publish the newly created knowledge object causing the system to duplicate the authored knowledge object information contained in FIG. 18 to its corresponding published information in FIG. 19 where the published knowledge object may be referenced, for example, by the system URL extended with for example the knowledge object's name, or extended with a unique number identifying the published knowledge object, thus creating a unique uniform resource locator (URL) for the published knowledge object. Execution returns to step 1110 of FIG. 11 where the user may author other knowledge objects.

FIG. 13 shows a flow chart of the system creating a rule within the create rule step 1212 of FIG. 12.

In step 1302 of FIG. 13, execution branches to step 1304 if the user would like to give a name to the rule being created. Otherwise, the system assigns a default rule name, for example ‘rule 1’, keeps the default rule name in a memory buffer RAM allocated for the rule creation, and execution branches to step 1306.

In step 1304, the system accepts a rule name entered by the user, and keeps the rule name in a memory buffer RAM allocated for the rule creation. Execution continues from step 1304 to step 1306.

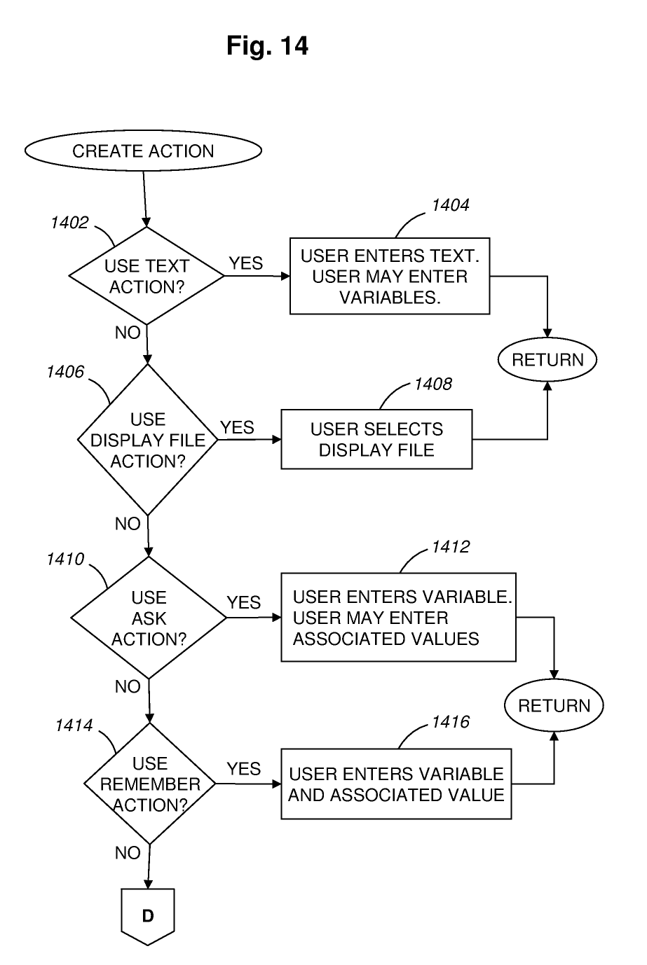

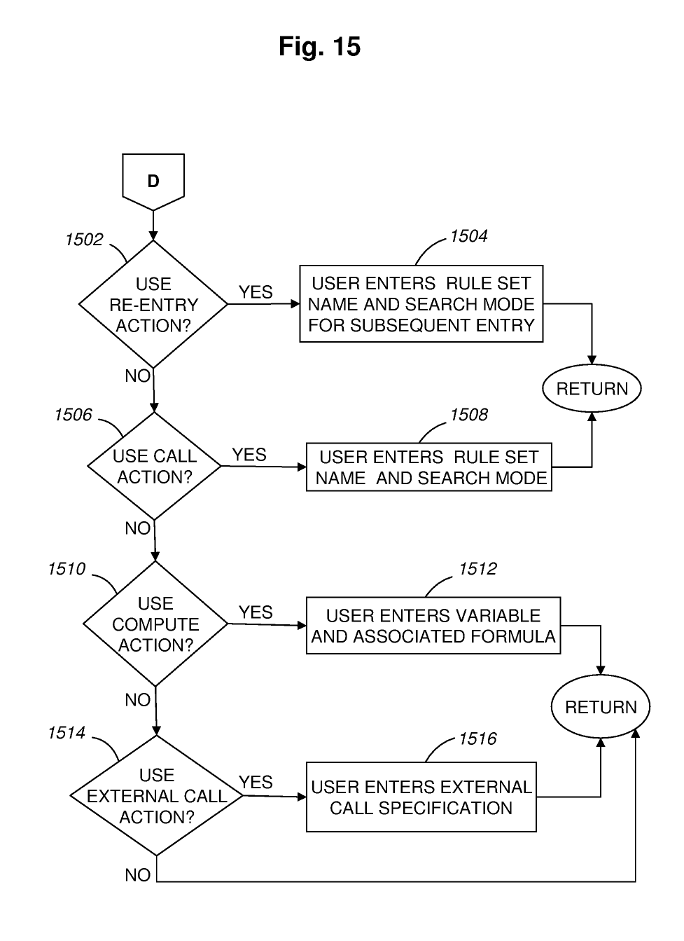

In step 1306, the system accepts an action entered by the user, and keeps the action in the memory buffer RAM allocated for the rule creation. The steps and procedure to create an action are further defined in FIG. 14 and FIG. 15. Execution continues from step 1306 to step 1308. In step 1308, execution branches back to step 1306 if the user would like to create another action. Otherwise execution branches to step 1310.

In step 1310, execution branches to step 1312 if the user would like to create a condition. Otherwise execution branches to step 1314.

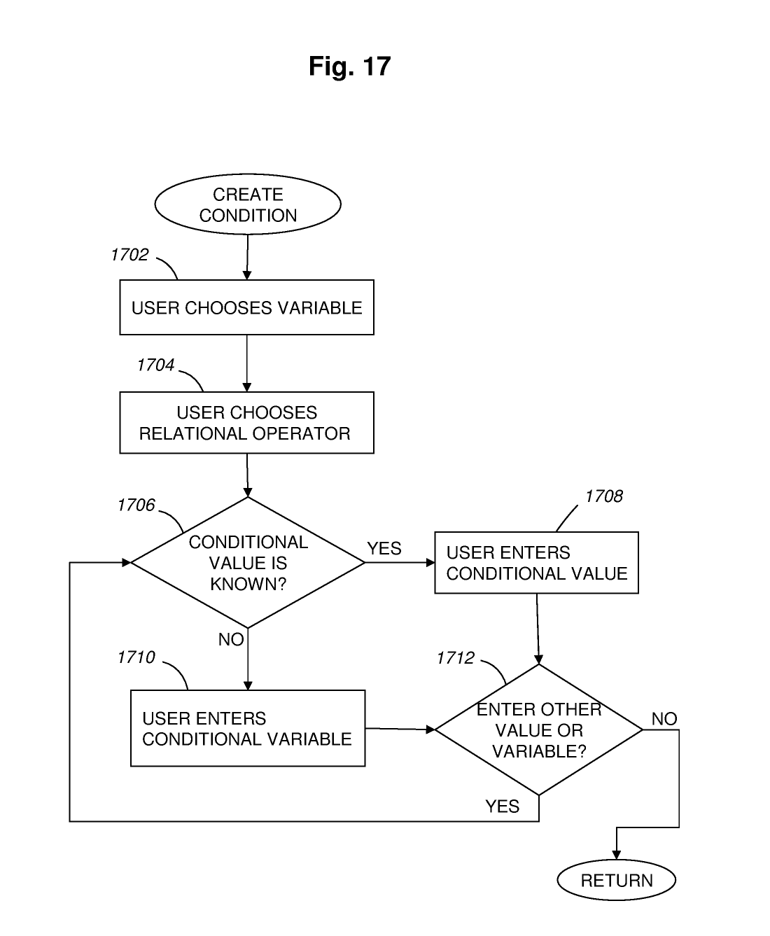

In step 1312, the system accepts a condition entered by the user, and keeps the condition in the memory buffer RAM allocated for the rule creation. The steps and procedure to create a condition are further defined in FIG. 17. Execution continues from step 1312 to step 1310 giving the user the opportunity of add another condition.

In step 1314, execution branches to step 1316 if the user would like to organize the rule under a rule set name of the user's choosing, or if the user would like to assign a sequence for the rule within the rule set. Otherwise, the system assigns, for that rule, a default rule set name and a default sequence number, and keeps the default rule set name and the default sequence number the memory buffer RAM allocated for the rule creation. Execution returns to step 1212 in FIG. 12.

In step 1316, the system accepts a rule set name and a sequence number, entered by the user, and keeps the rule set name and the rule' sequence number the memory buffer RAM allocated for the rule creation. A default rule set name is assigned by the system if the user leaves the rule set name field blank. A default sequence number is assigned by the system if the user leaves the sequence number entry field blank. Execution returns to step 1212 in FIG. 12.

FIG. 14 is the first sheet of a 2 sheets flow chart—FIG. 14, and FIG. 15—showing the system creating an action within the create action step 1306 of FIG. 13. The user selects a pre-defined action from a choice of pre-defined actions defined in the author action function of the system. In step 1402, execution branches to step 1404 if the user would like to create a text action. Otherwise execution branches to step 1406.

In step 1404, the system accepts text and may also accept a sequence number, entered by the user. The user may include variables within the entered text. If the user did not enter a sequence number, the system assigns a default sequence number for that action. The system updates the text action with the entered text information and with the action sequence number, and stores the text action in the memory buffer RAM allocated for the rule creation. An example of a screen adding a text action is shown in FIG. 32. Step 1404 is an example of authoring a web page component. Execution returns to step 1306 in FIG. 13.

In step 1406, execution branches to step 1408 if the user would like to create a display file action. Otherwise execution branches to step 1410.

In step 1408, the system accepts a file name, including the file path on the file system where the file is stored, a file display location (center, right, left) and may also accept a sequence number, entered by the user. If the user did not enter a sequence number, the system assigns a default sequence number for that action. The system updates the display file action with the entered information and with the action sequence number, and stores the display file action in the memory buffer RAM allocated for the rule creation. An example of screen adding a display file action is shown in FIG. 33. Step 1408 is another example of authoring a web page component. Execution returns to step 1306 in FIG. 13.

In step 1410, execution branches to step 1412 if the user would like to create an ask action. Otherwise execution branches to step 1414.

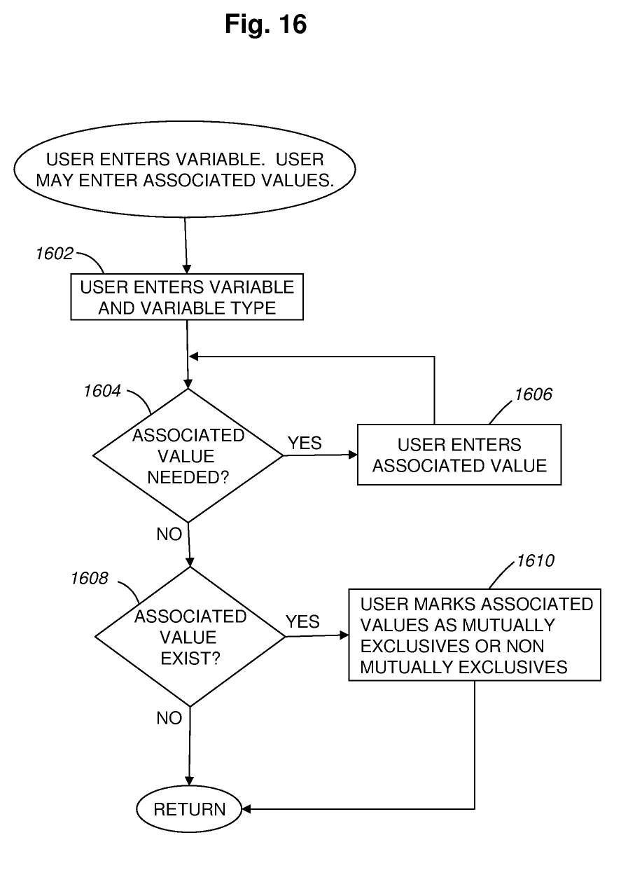

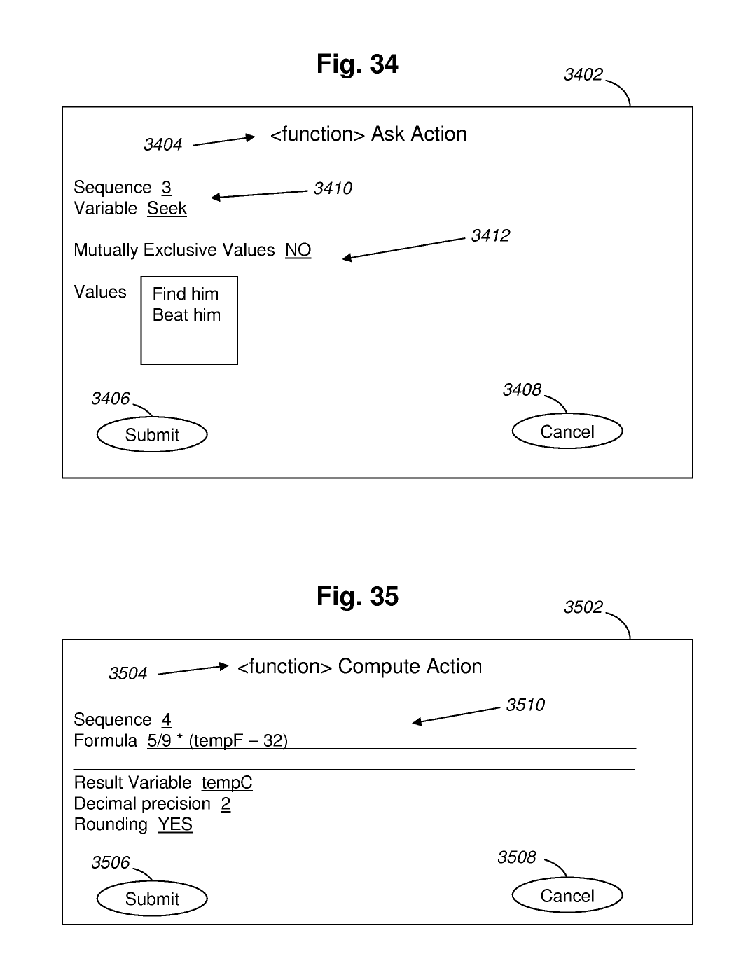

In step 1412, the system accepts a variable name, accepts variable values, if any, and a mutually exclusive indicator, and may also accept a sequence number, entered by the user. If the user did not enter a sequence number, the system assigns a default sequence number for that action. The system updates the ask action with the entered information and with the action sequence number, and stores the ask action in the memory buffer RAM allocated for the rule creation. Authoring an ask action is an example of authoring a user interface component; associating values to the variable is an example of creating a user selection component, otherwise an example of creating a user input component. When the values of an ask action are rule set links, authoring an ask action may also be an example of authoring a user selectable reference to a subset of rules within a knowledge object. An example of screen adding a user interface component with the ask action is shown in FIG. 34. Step 1412 is further defined in FIG. 16. Execution returns to step 1306 in FIG. 13.

In step 1414, execution branches to step 1416 if the user would like to create a remember action. Otherwise execution branches to step 1502 of FIG. 15.

In step 1416, the system accepts a variable name, a variable value, and may also accept a sequence number, entered by the user. If the user did not enter a sequence number, the system assigns a default sequence number for that action. The system updates the remember action with the entered information and with the action sequence number, and stores the remember action in the memory buffer RAM allocated for the rule creation. An example of screen adding a remember action is shown in FIG. 39. Execution returns to step 1306 in FIG. 13.

In step 1502 of FIG. 15, execution branches to step 1504 if the user would like to create a re-entry action. Otherwise execution branches to step 1506.

In step 1504, the system accepts a rule set name, a search mode, and may also accept a sequence number, entered by the user. If the user did not enter a sequence number, the system assigns a default sequence number for that action. The system updates the re-entry action with the entered information and with the action sequence number, and stores the re-entry action in the memory buffer RAM allocated for the rule creation. Authoring a re-entry action is an example of authoring a user selectable reference to a subset of rules within a knowledge object. An example of a screen adding a re-entry action is shown in FIG. 37. Execution returns to step 1306 in FIG. 13.

In step 1506, execution branches to step 1508 if the user would like to create a call action. Otherwise execution branches to step 1510.

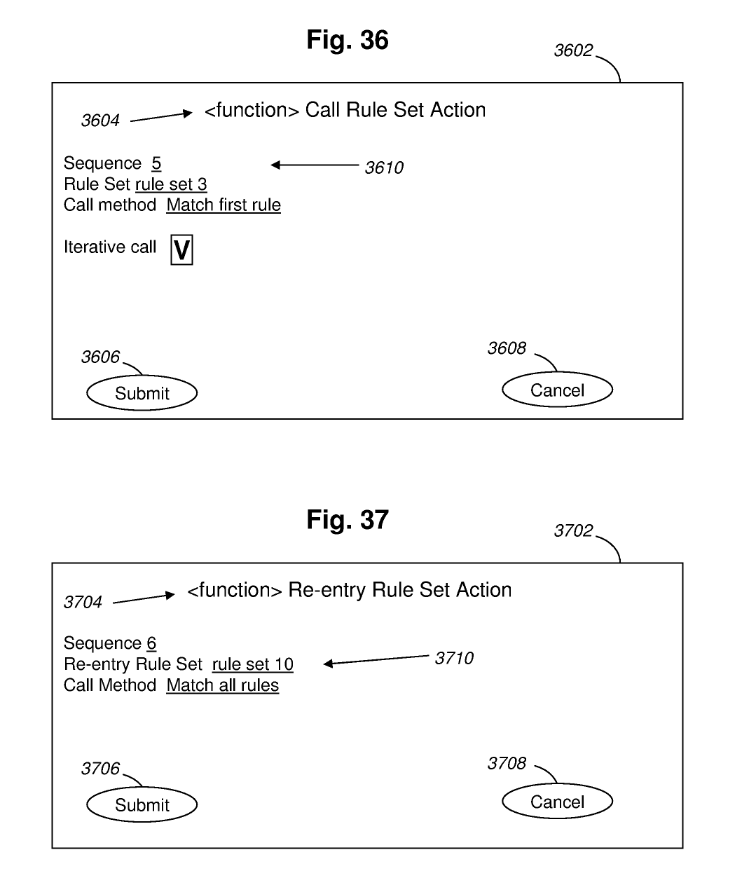

In step 1508, the system accepts a rule set name, a search mode, an iterative indicator, and may also accept a sequence number, entered by the user. If the user did not enter a sequence number, the system assigns a default sequence number for that action. The system updates the call action with the entered information and with the action sequence number, and stores the call action in the memory buffer RAM allocated for the rule creation. An example of screen adding a call action is shown in FIG. 36. This step is another example of authoring an invocation of a subset of the plurality of rules. Execution returns to step 1306 in FIG. 13.

In step 1510, execution branches to step 1512 if the user would like to create a compute action. Otherwise execution branches to step 1514.

In step 1512, the system accepts a variable, a formula, a precision scale, a rounding indicator, and may also accept a sequence number, entered by the user. If the user did not enter a sequence number, the system assigns a default sequence number for that action. The system updates the compute action with the entered information and with the action sequence number, and stores the compute action in the memory buffer RAM allocated for the rule creation. Step 1512 is an example of authoring a formula associated with a variable. An example of screen adding a compute action is shown in FIG. 35. Execution returns to step 1306 in FIG. 13.

In step 1514, execution branches to step 1516 if the user would like to create an external call action. Otherwise execution returns to step 1306 in FIG. 13.

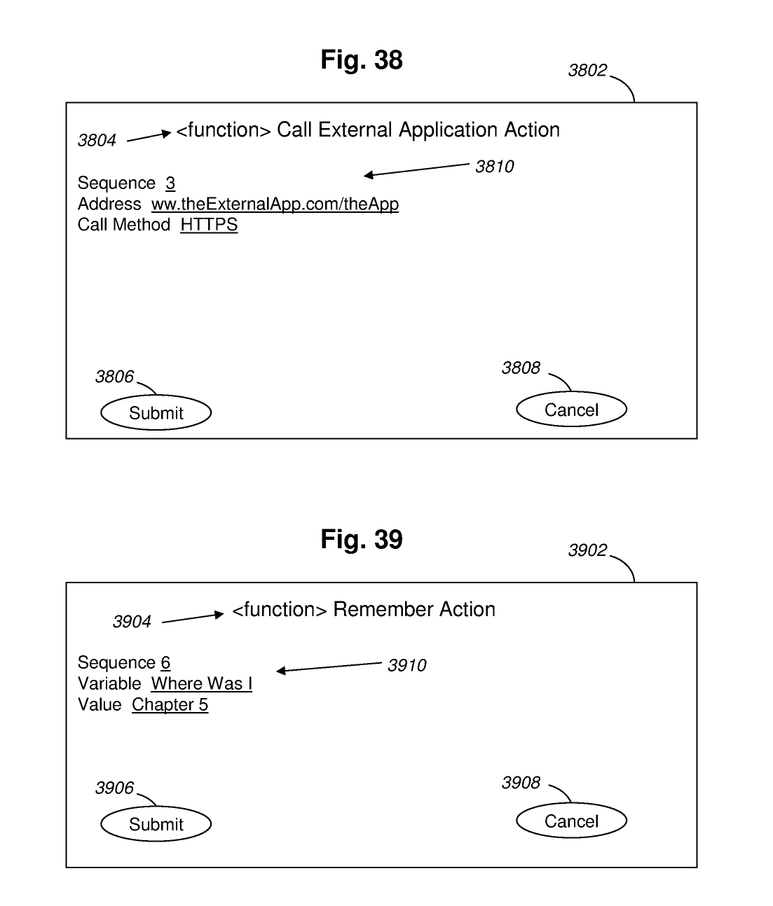

In step 1516, the system accepts an external system address, an external system method of communication, and may also accept a sequence number, entered by the user. If the user did not enter a sequence number, the system assigns a default sequence number for that action. The system updates the external call action with the entered information and with the action sequence number, and stores the external call action in the memory buffer RAM allocated for the rule creation. Step 1516 is an example of authoring a call to an independent computer implemented system. An example of screen adding a call external system action is shown in FIG. 38. Execution returns to step 1306 in FIG. 13.

The system for authoring, publishing and rendering knowledge objects can easily be augmented with additional pre-defined actions. The pre-defined actions, described in FIG. 14 and FIG. 15, are presented for illustrative purposes only and should not limit the scope and spirit of this invention.

FIG. 16 shows a flow chart of the system creating a variable with associated values, if any, within the user enters variable and may enter associated values step 1412 of FIG. 14.

In step 1602 of FIG. 16, the system accepts a variable name and a variable type, entered by the user. The variable type indicates if the variable represents of a set of characters, a number, a date, or a time. The variable type is needed by the system to correctly evaluate a logical statement, also called a condition, when the variable is contained in the logical statement. Execution continues from step 1602 to step 1604.

In step 1604, execution branches to step 1606 if the user would like to associate a value to the variable previously entered. Otherwise execution branches to step 1608.

In step 1606, the system accepts a value and associates the value with the variable entered in step 1602. Execution continues from step 1606 back to step 1604 allowing the user to enter additional values associated with the variable created in step 1602.

In step 1608, execution branches to step 1610 if at least two values are associated with the variable. Otherwise the system stores the variable name, the variable type and the variable's associated values, if any, in the memory buffer RAM allocated for the rule creation and execution returns to step 1412 of FIG. 14.

In step 1610, the system accepts either a mutually exclusive or a non-mutually exclusive setting, entered by the user. For example, mutually exclusive values for a variable called CAR may be Ford, Chrysler, Honda, Saturn, Toyota, and others because the variable CAR can only be one of these values. Another example would be for a variable called FEEL, non-mutually exclusive values may be tired, sick, and depress because a person may feel more than one of these sensations at one time. The system than stores the variable name, the variable type and the variable's associated values, if any, in the memory buffer RAM allocated for the rule creation and execution returns to step 1412 of FIG. 14.

FIG. 17 shows a flow chart of the system creating a condition within the create condition step 1312 of FIG. 13. A condition is a logical statement that evaluates to true or to false. A condition is composed of a left expression (named so because it resides, in the logical statement, on the left side of the operator), a logical operator, and a right expression (named so because it resides, in the logical statement, on the right side of the operator). In the present invention, the left expression is a variable and the right expression may be composed of a value, a variable, a function, or a combination of values, variables, and functions. The logical operator may be any of, but is not limited to, equals, not equal, less than, greater than, less than or equal to, greater than or equal to, starts with, ends with, contains, does not contain, exists, does not exist, is between, is not between, starts with any of, ends with any of, has one of its value less than, has one of its value greater than, has one of its value less than or equal to, has one of its value greater than or equal to, is contained in, is not contained in, shares any of, does not share any of, has length equal to, has length not equal to, has length less than, has length greater than, has length less than or equal to, has length greater than or equal to, etc. . . . .

In step 1702 of FIG. 17, the system accepts a variable name, selected by the user from the list of the user's predefined variables 1814, and updates the condition with the selected variable name. The variable name represents the left expression of the logical condition statement. Execution continues from step 1702 to step 1704.

In step 1704, the system accepts an operator, selected by the user from the list of operators available in the author condition function, and updates the condition with the selected operator. The list of operators is embedded in the author condition function 304. Execution continues from step 1704 to step 1706.

In step 1706, execution branches to step 1708 if the right side of the condition logical statement is a value known to the user. Otherwise, execution branches to step 1710.

In step 1708, the system accepts a value, entered by the user, and adds the entered value to the right expression of the logical statement. Alternatively, instead of entering a value, the user may select a value from the list of existing values 1816 associated with condition's left side variable. Execution continues from step 1708 to step 1712.

In step 1710, the system accepts a variable, selected by the user from the user defined variables logical segment 1814, and adds the selected variable to the right expression of the condition logical statement. Execution continues from step 1710 to step 1712.

In step 1712, execution branches to step 1706 if the user chooses to enter an additional value or an additional variable. Otherwise, the system stores the condition in the memory buffer RAM allocated for the rule creation, and execution returns to step 1312 of FIG. 13.

FIG. 18 shows a block diagram detailing the registered users' database 114 as composed of a number of logical segments and files. The registered users' database contains a plurality of registered user logical segment 1800. A registered user 1800 may have a plurality of knowledge object logical segment 1802. A knowledge object 1802 may have many rule-set logical segments 1804. A rule set 1804 may have many rule logical segments 1806. A rule 1806 may have a plurality of action logical segment 1808, and a plurality of condition logical segment 1810. A registered user 1800 may have a plurality of files 1812 residing on a disk file system reserved for the registered user. The files 1812 may be of different types identified by the files' extension. For example, a file with an extension of txt identifies a text type file, an html extension identifies an html type file, a jpg extension identifies a graphic type file, a wav extension identifies a sound type file, an mp3 extension identifies a video type file, etc. . . . . A registered user 1800 may have a plurality user defined variable logical segment 1814. A user defined variable 1814 may have a plurality of user defined variable value logical segment 1816. FIG. 18 describes the elements of a registered user database 114 at a logical level because there are a variety of possible physical implementations. One example of a difference between the logical representation and a physical layout may be a logical rule set segment physically represented as a single attribute in a rule's physical segment.

FIG. 19 shows a block diagram detailing the published knowledge objects database 116 as composed of a number of logical segments and files. A published knowledge object may be uniquely referenced by a uniform resource locator (URL) comprising the system's URL extended with for example the knowledge object's name, or the system's URL extended with, as another example, a unique number identifying the published knowledge object. A published knowledge object 1902 may have many rule-set logical segments 1904. A rule set 1904 may have may rule logical segments 1906. A rule 1906 may have a plurality of action logical segment 1908, and a plurality of condition logical segment 1910. A published knowledge object 1902 may have a plurality of files 1912 residing on a disk file system reserved for the published knowledge object. The files 1912 may be of different types identified by the files' extension. For example, a file with an extension of txt identifies a text type file, an htm extension identifies an html type file, a gif extension identifies a graphic type file, an acc extension identifies a sound type file, an avi extension identifies a video type file, etc. . . . . A published knowledge object 1902 may have a plurality of variable logical segment 1914. A variable 1914 may have a plurality of variable value logical segment 1916. FIG. 19 describes the elements of a published knowledge object database 116 at a logical level because there are a variety of possible physical implementations. One example of a difference between the logical representation and a physical layout may be a logical rule set segment physically represented as a single attribute in a rule's physical segment.

FIG. 20 shows a web page as seen by a user when browsing the database of published knowledge objects. A user may search the database of published knowledge objects by using key word search, by searching through the published knowledge objects' categories and sub-categories, or by using a combination of key word and categories and sub-categories search. A user may enter key words in the search field 2002 and press the submit button 2004 for the system to search the published knowledge objects and to display, in the web page area 2008, web page links associated with the published knowledge objects whose key words match the key words entered by the user. If the number of published knowledge objects returned by the search is too large to display them on the web page, the web page area 2008 will display a restricted set of the returned published knowledge objects, and provide paging controls 2010, 2012 to allow the user to continue browsing the published knowledge objects returned by the search but not displayed on the web page. Alternatively, a user may select a published knowledge object category in area 2006 of the web page. Examples of published knowledge objects' categories and sub-categories are provided in FIG. 4. In this example, the system displays the selected category's sub-categories in the same display area 2006, and displays web page links associated with the published knowledge objects belonging in the selected category in the web page area 2008. If the number of published knowledge objects belonging in the selected category is too large to display them on the web page, the page area 2008 will display a restricted set of the published knowledge objects belonging to the selected category and provide paging controls 2010, 2012 to allow the user to continue browsing the published knowledge objects in the selected category. Alternatively, a user may use a combination of key word search and category or sub-category selection to further restrict the list of returned published knowledge objects. Once a web link associated with a published knowledge object is displayed in the web page area 2008, a user may experience an instance of the knowledge object by selecting its web link.

FIG. 21 shows a web page as seen by a user when experiencing an instance of a published knowledge object rendered as a dynamic interactive web page. In this example, a user selected a web page link associated with a knowledge object displayed in the web page area 2008 of FIG. 20. The system responded to the user's selection by loading an instance of, and invoking the selected knowledge object. The knowledge object's invocation caused the web page area 2008 of FIG. 20 to change its display as shown for example by the web page area 2102 of FIG. 21. In this example, the dynamic interactive web page rendered by the selected knowledge objects presents it's name, author, and rating in page area 2104, presents a first question with two non-mutually exclusive answer options, indicated by the arrow 2108, presents a second question with four mutually exclusive answer options, indicated by the arrow 2110, and provides a continue button 2112 allowing the user to communicate the user's answers to the said knowledge object. In this example, the knowledge object instance will return the user's needed information after the user communicates the answers' choice to the knowledge object. The number of back and forth question and answer choice, between a user and an instance of a knowledge object, depends on the knowledge needed by the user and the organization of the needed knowledge within the knowledge object.

FIG. 22 is a display screen as seen by a user for authoring knowledge objects, variables and their associated values. In order to access the display screen in FIG. 22, a user must be registered and authenticated by the system. The display screen FIG. 22 is composed of four screen areas. The first screen area 2202, called a tool bar, makes all the authoring functions 304 available to the user. The tool bar has a drop down menu for knowledge object functions which is further defined in FIG. 23, a drop down menu for rule functions which is further defined in FIG. 24, a drop down menu for condition functions which is further defined in FIG. 25, a drop down menu for action functions which is further defined in FIG. 26, a drop down menu for variable functions which is further defined in FIG. 27, and an upload file function that enables a user to transfer a copy of a file from the user's personal computer to the system for authoring, publishing and rendering knowledge objects. The second screen area 2204 displays references to the user's knowledge objects and their components, which are rule set, rules, actions and conditions. The third screen area 2206 displays references to the user's defined variables. The fourth screen area 2208 displays the details of a selected knowledge object or a selected knowledge object component in the screen area 2204, or of a selected variable in the screen area 2206. A first time user, having no knowledge object, may invoke the add knowledge object function by selecting the add drop down menu option of the knowledge object option of the tool bar 2202. The invocation of the add knowledge object function causes knowledge object data entry fields, a submit button, and a cancel button, as shown for example in FIG. 28, to display in the screen area 2208. The system accepts the knowledge object data and the submit command, entered by the user, creates a knowledge object segment 1802 of FIG. 18, and displays the knowledge object's name in the screen area 2204. Similarly, a first time user, having no rule, may select a knowledge object, and invoke the add rule function by selecting the add rule drop down menu option of the knowledge object option of the tool bar 2202. The invocation of the add rule function causes a rule data entry fields, a submit button, and a cancel button, as shown for example in FIG. 29, to display in the screen area 2208. The system accepts the rule data and the submit command, entered by the user, creates a rule set segment 1804 and rule segment 1806, and displays the rule set name and the rule name in the screen area 2204. If the user entered a rule set name in the rule set data entry field of the rule being created, the system creates, if one doesn't already exists, a rule set using the entered rule set name, and display the rule set name in a hierarchy between the knowledge object name and the rule name in screen area 2204. If the user leave the rule set name data entry field blank, the system assigns a default rule set name for the created rule. A first time user, having no condition, may select a rule, and invoke the add condition function by selecting the add condition drop down menu option of the rule option of the tool bar 2202. The invocation of the add condition function causes a condition data entry fields, a submit button, and a cancel button, as shown for example in FIG. 31, to display in the screen area 2208. The system accepts the condition data and the submit command, entered by the user, creates a condition segment 1810, and displays a system generated condition name, for example Condition 1, in the screen area 2204. Similarly, a first time user, having no variable, may invoke the add function by selecting the add drop down menu option of the variable option of the tool bar 2202. The invocation of the add variable function causes a variable data entry fields, a submit button, and a cancel button, as shown for example in FIG. 30, to display in the screen area 2208. The system accepts the variable data and the submit command, entered by the user, creates a user defined variable segment 1814 and may create a plurality of user defined variable value segments 1816, and displays the variable's name in the screen area 2206. Similarly, a first time user, having no action, may select a rule, and invoke the add action function by selecting the add action drop down menu option of the rule option of the tool bar 2202, and then selecting the desired type of action from an action list appearing as a sub-menu as shown in FIG. 24. The invocation of the add action function causes the selected action's data entry fields, a submit button, and a cancel button, as shown for example in FIG. 32 for adding a text action, to display in the screen area 2208. The system accepts the action data and the submit command, entered by the user, creates an action segment 1808, and displays the action's name in the screen area 2204. A user may select any component name in the screen area 2204, or a variable name in the screen area 2206, and the system displays the selected component detail in screen area 2208, and enables the selected component's other functions in the component's corresponding menu residing in the tool bar 2202. If the selected component in area 2204 is a knowledge object, the system also displays the hierarchy of the knowledge object's components, rule sets, rules, conditions, and actions, in the screen area 2204 just below and indented with the knowledge object's name.

To update, delete, publish, un-publish, or test a knowledge object, a user selects the knowledge object's name in the screen area 2204, invokes the desired function by expending the knowledge object drop down menu option on the tool bar 2202, and by selecting the desired function within the extended drop down menu FIG. 23. If the invoked function is an update, delete, publish, or un-publish function, the system displays, in screen area 2208, the knowledge object's detail information and a control button to execute the function as shown for example in FIG. 28. If the invoked function is a test function, the screen area 2208 renders an instance of the selected knowledge object, and creates a sub-area 2210 where the step-by-step execution, of the knowledge object being tested, is displayed. An update function causes the system to update the selected knowledge object's segment 1802, and to update, if necessary, the knowledge object's name in the screen area 2204. A delete function causes the system to delete the selected knowledge object's segment 1802, and its associated rule set segments 1804, and its associated rule segments 1806, and its associated action segments 1808, and its associated condition segment 1810, and to remove the knowledge object's name and sub-components from the screen area 2204. A publish function causes the system to copy the segments of the selected knowledge object, that is segments 1802, 1804, 1806, 1808, and 1810, to the published knowledge object segments 1902, 1904, 1906, 1908, and 1910 respectively. The publish function also causes the system to copy variables and their associated values used by the selected knowledge object from segments 1814 and 1816 to the published knowledge object segments 1914 and 1916 respectively. The publish function also causes the system to copy files 1812 used by the selected knowledge object to a file area 1912 reserved for the published knowledge object. A un-publish function causes the system to delete the published knowledge objects segment 1902 and all its logical dependent segments and files. To update or delete a rule, a user selects the rule's name in the screen area 2204, and invokes the desired function by expending the rule drop down menu option on the tool bar 2202 and by selecting the desired function within the extended drop down menu FIG. 24. This user's action causes the system to display, in screen area 2208, the rule's detail information and a control button to execute the invoked function, as shown for example in FIG. 29. An update function causes the system to update the selected rule's segment 1806, and to update the rule's name, if necessary, in the screen area 2204. A delete function causes the system to delete the selected rule's segment 1806, and its associated action segments 1808, and its associated condition segment 1810, and its associated rule set 1804 if the rule deleted was the last rule in the rule set, and to remove the rule's name and sub-components from the screen area 2204. To re-order a rule, a user selects the rule's name in the screen area 2204, and invokes the move-up or move-down function by expending the rule drop down menu option on the tool bar 2202 and selecting the move-up or move-down function within the extended drop down menu FIG. 24. If the invoked function is a move-up function, the system decreases, by one, the selected rule's sequence number, and increases, by one, the sequence number of the rule immediately preceding the selected rule. If the invoked function is a move-down function, the system increases, by one, the selected rule's sequence number, and decreases, by one, the sequence number of the rule immediately after the of the selected rule. With each move-down and move-up function, the system re-orders the rules' name displayed in screen area 2204. The rules' sequence number determines the sequence in which the rules are evaluated within a rule set. To update or delete a variable, a user selects the variable's name in the screen area 2206, and invokes the desired function by expending the variable drop down menu option on the tool bar 2202 and by selecting the desired function within the extended drop down menu FIG. 27. This user's action causes the system to display, in screen area 2208, the variable's detail information and a control button to execute the invoked function, as shown for example in FIG. 30. An update function causes the system to update the selected variable segment 1814, its associated variable value segment 1816, and if necessary, the display of the variable's name in screen area 2206. A delete function causes the system to delete the selected variable segment 1814, its associated variable value segments 1816, and to remove the variable's name from the screen area 2206. To update or delete a condition, a user selects the condition's name in the screen area 2204, and invokes the desired function by expending the condition drop down menu option on the tool bar 2202 and by selecting the desired function within the extended drop down menu FIG. 25. This user's action causes the system to display, in screen area 2208, the condition's detail information and a control button to execute the invoked function as shown for example in FIG. 31. An update function causes the system to update the selected condition segment 1810. A delete function causes the system to delete the selected rule segment 1810, and to remove the condition's name from the screen area 2204. To re-order a condition, a user selects the condition's name in the screen area 2204, and invokes the move-up or move-down function by expending the condition drop down menu option on the tool bar 2202 and selecting the move-up or move-down function within the expended drop down menu FIG. 25. If the invoked function is a move-up function, the system decreases, by one, the selected condition's sequence number, and increases, by one, the sequence number of the condition immediately preceding the selected condition. If the invoked function is a move-down function, the system increases, by one, the selected condition's sequence number, and decreases, by one, the sequence number of the condition immediately after the of the selected condition. The condition's sequence number determines the sequence in which a condition is evaluated within a rule. To update or delete an action, a user selects the action's name in the screen area 2204, and invokes the desired function by expending the action drop down menu option on the tool bar 2202 and by selecting the desired function within the expended drop down menu FIG. 26. This user's action causes the system to display, in screen area 2208, the action's detail information and a control button to execute the invoked function as shown for example, depending on the action, in FIG. 32, FIG. 33, FIG. 34, FIG. 35, FIG. 36, FIG. 37, FIG. 38, or FIG. 39. To re-order an action, a user selects the action's name in the screen area 2204, and invokes the move-up or move-down function by expending the action drop down menu option on the tool bar 2202 and selecting the move-up or move-down function within the expended drop down menu FIG. 26. If the invoked function is a move-up function, the system decreases, by one, the selected action's sequence number, and increases, by one, the sequence number of the action immediately preceding the selected action. If the invoked function is a move-down function, the system increases, by one, the selected action's sequence number, and decreases, by one, the sequence number of the action immediately after the of the selected action. With each move-down and move-up function, the system re-orders the actions' name displayed in screen area 2204. The action's sequence number determines the sequence in which an action is executed within a rule.

FIG. 23 displays the knowledge object function options when the knowledge object option on the tool bar 2202 of FIG. 22 is extended as a dropdown menu. The update, delete, test, and add rule functions are enabled only when a knowledge object's name in the screen area 2204 of FIG. 22 is selected. The publish function is enabled only when a knowledge object's name in the screen area 2204 is selected and when the knowledge object, referenced by the selection, is in a un-published state, or is in a published state but has been locally modified since the last publication. The un-publish function is enabled only when a knowledge object's name in the screen area 2204 is selected and when the knowledge object, referenced by the selection, is in a published state. FIG. 24 displays the rule function options when the rule option on the tool bar 2202 of FIG. 22 is extended as a dropdown menu. The update, delete, move-up, move-down, add condition, and add action functions are enabled only when a rule's name in the screen area 2204 of FIG. 22 is selected. The text, ask, display file, compute, call rule set, re-entry rule set, external call, and remember options only displayed when the add action function is selected.

FIG. 25 displays the condition function options when the condition option on the tool bar 2202 of FIG. 22 is extended as a dropdown menu. The update, delete, move-up, and move-down functions are enabled only when a condition's name in the screen area 2204 of FIG. 22 is selected.

FIG. 26 displays the action function options when the action option on the tool bar 2202 of FIG. 22 is extended as a dropdown menu. The update, delete, move-up, and move-down functions are enabled only when an action's name in the screen area 2204 of FIG. 22 is selected.

FIG. 27 displays the variable function options when the variable option on the tool bar 2202 of FIG. 22 is extended as a dropdown menu. The update and delete functions are enabled only when a variable's name in the screen area 2206 of FIG. 22 is selected.

Item 2802 in FIG. 28 shows a display screen area, as seen by a user in screen area 2208 of FIG. 22, when an add, update, delete, publish, or un-publish function is invoked on a knowledge object. The name of the invoked function, for example update, is displayed instead of the generic expression <function> indicated by the arrow 2804. In this example, the user enters data in the name and description data entry fields indicated by the arrow 2810. Also indicated by the arrow 2810 is the field status which is changeable, by the user, via the publish and un-publish functions. The system generated fields, rating, usage, original published date, last published date, and last update date, indicated by the arrow 2812, are displayed to the user. The user may perform the invoked function by pressing the submit button 2806, or may cancel the invoked function by pressing the cancel button 2808. When a knowledge object's detail information is only displayed, for example by selecting a knowledge object's name in the screen area 2204 of FIG. 22, it is displayed as shown in the screen area 2802 except that the data entry fields 2810 are disabled, and the generic expression <function> 2804, the submit button 2806, and the cancel button 2808 are not displayed.

Item 2902 in FIG. 29 shows a display screen area, as seen by a user in screen area 2208 of FIG. 22, when an add, update, or delete function is invoked on a rule. The name of the invoked function, for example update, is displayed instead of the generic expression <function> indicated by the arrow 2904. In this example, the user enters data in the rule's name, rule set name and sequence data entry fields indicated by the arrow 2910. The action display and condition display fields, indicated by the arrow 2912, are display only fields for the user's convenience. The user may perform the invoked function by pressing the submit button 2906, or may cancel the invoked function by pressing the cancel button 2908. When a rule's detail information is only displayed, for example by selecting a rule name in the screen area 2204 of FIG. 22, it is displayed as shown in the screen area 2902 except that the data entry fields 2910 are disabled, and the generic expression <function> 2904 is blank, and the submit 2906 and cancel 2908 buttons are not displayed.

Item 3002 in FIG. 30 shows a display screen area, as seen by a user in screen area 2208 of FIG. 22, when an add, update, or delete function is invoked on a variable. The name of the invoked function, for example update, is displayed instead of the generic expression <function> indicated by the arrow 3004. In this example, the user enters data in the variable's name, may enter a plurality of values, selects a variable type, checks or un-checks the mutually exclusive check-box, in the data entry fields indicated by the arrow 3010. The user may perform the invoked function by pressing the submit button 3006, or may cancel the invoked function by pressing the cancel button 3008. When a variable's detail information is only displayed, for example by selecting a variable name in the screen area 2206 of FIG. 22, it is displayed as shown in the screen area 3002 except that the data entry fields 3010 are disabled, and the generic expression <function> 3004, the submit button 3006, and the cancel button 3008 are not displayed.

Item 3102 in FIG. 31 shows a display screen area, as seen by a user in screen area 2208 of FIG. 22, when an add, update, or delete function is invoked on a condition. The name of the invoked function, for example update, is displayed instead of the generic expression <function> indicated by the arrow 3104. In this example, the user selects a variable name from a list of variable names generated from the segments 1814, selects an operator from a list of operators generated by the author condition function, selects a variable's value from a list of variable values generated from the segments 1816, and enters a sequence number in the data entry fields indicated by the arrow 3010. The user may perform the invoked function by pressing the submit button 3106, or may cancel the invoked function by pressing the cancel button 3108. When a condition's detail information is only displayed, for example by selecting a condition name in the screen area 2204 of FIG. 22, it is displayed as shown in the screen area 3102 except that the data entry fields 3110 are disabled, and the generic expression <function> 3104, the submit button 3106, and the cancel button 3108 are not displayed.

Item 3202 in FIG. 32 shows a display screen area, as seen by a user in screen area 2208 of FIG. 22, when an add, update, or delete function is invoked on a text action. The name of the invoked function, for example update, is displayed instead of the generic expression <function> indicated by the arrow 3204. In this example, the user enters a sequence number and a text, in the data entry fields indicated by the arrow 3210. The user may perform the invoked function by pressing the submit button 3206, or may cancel the invoked function by pressing the cancel button 3208. When a text action's detail information is only displayed, for example by selecting an action name in the screen area 2204 of FIG. 22, it is displayed as shown in the screen area 3202 except that the data entry fields 3210 are disabled, and the generic expression <function> 3204, the submit button 3206, and the cancel button 3208 are not displayed.

Item 3302 in FIG. 33 shows a display screen area, as seen by a user in screen area 2208 of FIG. 22, when an add, update, or delete function is invoked on a display file action. The name of the invoked function, for example update, is displayed instead of the generic expression <function> indicated by the arrow 3304. In this example, the user enters a sequence number, a file name inclusive of the file path on the disk file system, and a display location, in the data entry fields indicated by the arrow 3310. The user may perform the invoked function by pressing the submit button 3306, or may cancel the invoked function by pressing the cancel button 3308. When a display file action's detail information is only displayed, for example by selecting an action name in the screen area 2204 of FIG. 22, it is displayed as shown in the screen area 3302 except that the data entry fields 3310 are disabled, and the generic expression <function> 3304, the submit button 3306, and the cancel button 3308 are not displayed.

Item 3402 in FIG. 34 shows a display screen area, as seen by a user in screen area 2208 of FIG. 22, when an add, update, or delete function is invoked on an ask action. The name of the invoked function, for example update, is displayed instead of the generic expression <function> indicated by the arrow 3404. In this example, the user enters a sequence number and selects a variable, in the data entry fields indicated by the arrow 3410. The values box and the mutually exclusive fields, indicated by the arrow 3412, are display only fields for the user's convenience. The user may perform the invoked function by pressing the submit button 3406, or may cancel the invoked function by pressing the cancel button 3408. When a ask action's detail information is only displayed, for example by selecting an action name in the screen area 2204 of FIG. 22, it is displayed as shown in the screen area 3402 except that the data entry fields 3410 are disabled, and the generic expression <function> 3404, the submit button 3406, and the cancel button 3408 are not displayed.

Item 3502 in FIG. 35 shows a display screen area, as seen by a user in screen area 2208 of FIG. 22, when an add, update, or delete function is invoked on a compute action. The name of the invoked function, for example update, is displayed instead of the generic expression <function> indicated by the arrow 3504. In this example, the user enters a sequence number, a formula, a result variable, a decimal precision number, and a rounding indicator, in the data entry fields indicated by the arrow 3510. The user may perform the invoked function by pressing the submit button 3506, or may cancel the invoked function by pressing the cancel button 3508. When a compute action's detail information is only displayed, for example by selecting an action name in the screen area 2204 of FIG. 22, it is displayed as shown in the screen area 3502 except that the data entry fields 3510 are disabled, and the generic expression <function> 3504, the submit button 3506, and the cancel button 3508 are not displayed.

Item 3602 in FIG. 36 shows a display screen area, as seen by a user in screen area 2208 of FIG. 22, when an add, update, or delete function is invoked on a call rule set action. The name of the invoked function, for example update, is displayed instead of the generic expression <function> indicated by the arrow 3604. In this example, the user enters a sequence number, a rule set name, a call method, and an iterative indicator in the data entry fields indicated by the arrow 3610. The user may perform the invoked function by pressing the submit button 3606 thus creating an invocation of a subset of rules within a knowledge object, or may cancel the invoked function by pressing the cancel button 3608. When a call rule set action's detail information is only displayed, for example by selecting an action name in the screen area 2204 of FIG. 22, it is displayed as shown in the screen area 3602 except that the data entry fields 3610 are disabled, and the generic expression <function> 3604, the submit button 3606, and the cancel button 3608 are not displayed.

Item 3702 in FIG. 37 shows a display screen area, as seen by a user in screen area 2208 of FIG. 22, when an add, update, or delete function is invoked on a re-entry rule set action. The name of the invoked function, for example update, is displayed instead of the generic expression <function> indicated by the arrow 3704. In this example, the user enters a sequence number, a call rule set name, and a call method, in the data entry fields indicated by the arrow 3710. The user may perform the invoked function by pressing the submit button 3706, or may cancel the invoked function by pressing the cancel button 3708. When a re-entry action's detail information is only displayed, for example by selecting an action name in the screen area 2204 of FIG. 22, it is displayed as shown in the screen area 3702 except that the data entry fields 3710 are disabled, and the generic expression <function> 3704, the submit button 3706, and the cancel button 3708 are not displayed.

Item 3802 in FIG. 38 shows a display screen area, as seen by a user in screen area 2208 of FIG. 22, when an add, update, or delete function is invoked on a call external application action. The name of the invoked function, for example update, is displayed instead of the generic expression <function> indicated by the arrow 3804. In this example, the user enters a sequence number, an application address, and a call method, in the data entry fields indicated by the arrow 3810. The user may perform the invoked function by pressing the submit button 3806, or may cancel the invoked function by pressing the cancel button 3808. When a call external application action's detail information is only displayed, for example by selecting an action name in the screen area 2204 of FIG. 22, it is displayed as shown in the screen area 3802 except that the data entry fields 3810 are disabled, and the generic expression <function> 3804, the submit button 3806, and the cancel button 3808 are not displayed.

Item 3902 in FIG. 39 shows a display screen area, as seen by a user in screen area 2208 of FIG. 22, when an add, update, or delete function is invoked on a remember action. The name of the invoked function, for example update, is displayed instead of the generic expression <function> indicated by the arrow 3904. In this example, the user enters a sequence number, a variable, and a value, in the data entry fields indicated by the arrow 3910. The user may perform the invoked function by pressing the submit button 3906, or may cancel the invoked function by pressing the cancel button 3908. When a remember action's detail information is only displayed, for example by selecting an action name in the screen area 2204 of FIG. 22, it is displayed as shown in the screen area 3902 except that the data entry fields 3910 are disabled, and the generic expression <function> 3904, the submit button 3906, and the cancel button 3908 are not displayed.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A method of generating a web page comprising:
mapping a plurality of rules to one uniform resource locator (URL), each rule comprising at least one action and at least one condition, said action generating a web page component;
generating a web page as a function of assembling the generated web page components of the actions of at least one rule whose at least one condition is met.

2. The method of claim 1, wherein an action comprises invoking a subset of the plurality of rules, wherein said invocation is one of a single invocation and an iterative invocation.

3. The method of claim 1, wherein an action comprises generating at least one user interface component, wherein said user interface component is one of a user input component and a user selection component.

4. The method of claim 1, wherein an action comprises generating a user selectable reference to a subset of the plurality of rules in such a way that said user selectable reference invokes said subset of the plurality of rules when selected.

5. The method of claim 1, wherein an action comprises generating a variable value pair, wherein said value is set according to the evaluation of a formula.

6. The method of claim 1, wherein an action comprises substituting at least one variable with its respective run-time value.

7. The method of claim 1, wherein an action comprises calling an independent computer implemented method.

8. The method of claim 1, wherein a rule with no associated condition evaluates to having its conditions met.

9. A computer implemented system for providing a dynamically generated web page comprising:
means of mapping a plurality of rules to one uniform resource locator (URL), each rule comprising at least one action and at least one condition, said action comprising means of generating a web page component;
means of assembling the actions' generated web page components of at least one rule whose conditions are met.

10. The computer implemented system of claim 9, wherein an action comprises means of invoking a subset of the plurality of rules, wherein said means of invocation is one of means of a single invocation and means of an iterative invocation.

11. The computer implemented system of claim 9, wherein an action comprises means of generating at least one user interface component, wherein said user interface component is one of a user input component and a user selection component.

12. The computer implemented system of claim 9, wherein an action comprises means of generating a user selectable reference to a subset of the plurality of rules in such a way that said user selectable reference invokes said subset of the plurality of rules when selected.

13. The computer implemented system of claim 9, wherein an action comprises means of generating a variable value pair, wherein said value is set according to the evaluation of a formula.

14. The computer implemented system of claim 9, wherein an action comprises means of substituting at least one variable with its respective run-time value.

15. The computer implemented system of claim 9, wherein an action comprises means of calling an independent computer implemented system.

16. The computer implemented system of claim 9, wherein a rule with no associated condition evaluates to having its conditions met.

17. The computer implemented system of claim 9, further comprising means of finding a plurality of rules wherein the finding means is one or a combination of:
means of finding the said plurality of rules by using a key word search;
means of finding the said plurality of rules by browsing through the plurality of plurality of rules;
means of finding said plurality of rules by browsing through the categories and sub-categories of the plurality of rules.

18. A method for authoring a web page comprising:
authoring a plurality of rules, each rule comprising at least one action and at least one condition;
authoring an action comprising authoring a web page component, said action associated with a rule within the said plurality of rules.

19. The method of claim 18, wherein authoring an action comprises authoring a user interface component, wherein said user interface component is one of a user input component and a user selection component.

20. The method of claim 18, wherein authoring an action comprises authoring a user selectable reference to a subset of said plurality of rules.

21. The method of claim 18, wherein authoring an action comprises authoring an invocation of a subset of the plurality of rules, wherein said invocation is one of a single invocation and an iterative invocation.

22. The method of claim 18, wherein authoring an action comprises authoring a formula associated with a variable.

23. The method of claim 18, wherein authoring an action comprises authoring a call to an independent computer implemented system.

24. The method of claim 18, further comprising publishing the plurality of rules in such a way that said plurality of rules maps to one uniform resource locator (URL).

25. A computer implemented system for authoring a dynamic interactive web page comprising:
means of authoring a plurality of rules, each rule comprising at least one action and at least one condition;
means of authoring an action comprising means of authoring a web page component, said action associated with a rule within the said plurality of rules.

26. The computer implemented system of claim 25, wherein means of authoring an action comprises means of authoring a user interface component, wherein said user interface component is one of a user input component and a user selection component.

27. The computer implemented system of claim 25, wherein means of authoring an action comprises means of authoring a user selectable reference to a subset of the plurality of rules.

28. The computer implemented system of claim 25, wherein means of authoring an action comprises means of authoring an invocation of a subset of the plurality of rules, wherein said invocation is one of a single invocation and an iterative invocation.

29. The computer implemented system of claim 25, wherein means of authoring an action comprises means of authoring a formula associated with a variable.

30. The computer implemented system of claim 25, wherein means of authoring an action comprises means of authoring a call to an independent computer implemented system.

31. The computer implemented system of claim 25, further comprising means of publishing the plurality of rules in such a way that said plurality of rules maps to one uniform resource locator (URL).

32. One or more computer readable media comprising computer executable instructions that, when executed, direct a computing device to generate a computer implemented system, the one or more computer readable media further comprising computer executable instructions for authoring a plurality of rules, each rule comprising means of generating at least one web page component and at least one condition, and for rendering a web page as a function of assembling the generated web page components of at least one rule whose conditions are met.

33. The one or more computer readable media of claim 32, further comprising computer executable instructions for publishing said plurality of rules in such a way that said plurality of rules maps to one uniform resource locator (URL).
